(19) United States
(12) Patent Application Publication
(10) Pub. No.: US 2015/0350624 A1
(43) Pub. Date: Dec. 3, 2015

(54) METHOD AND APPARATUS FOR GENERATING 3D IMAGE DATA STREAM, METHOD AND APPARATUS FOR PLAYING 3D IMAGE DATA STREAM

(71) Applicant: SAMSUNG ELECTRONICS CO., LTD., Suwon-si (KR)

(72) Inventors: Byeong-doo CHOI, Siheung-si (KR); Jae-hyun KIM, Seoul (KR); Jeong-hoon PARK, Seoul (KR); Chan-yul KIM, Bucheon-si (KR)

(73) Assignee: SAMSUNG ELECTRONICS CO., LTD., Suwon-si (KR)

(21) Appl. No.: 14/412,553

(22) PCT Filed: Jul. 2, 2013
(86) PCT No.: PCT/KR2013/005871

§ 371 Date: Jan. 2, 2015

Related U.S. Application Data
(60) Provisional application No. 61/667,118, filed on Jul. 2, 2012.

(51) Int. Cl. H04N 13/00; H04N 21/434; H04N 21/236; H04N 21/2343; H04N 21/81

(52) U.S. Cl. CPC H04N 13/0048; H04N 13/0066; H04N 21/234327; H04N 21/816; H04N 21/236; H04N 21/434; H04N 2013/0096

(57) ABSTRACT

A method of generating a 3-dimensional (3D) image data stream includes encoding a first partial image including half of data of a 3D image including a first viewpoint image in full resolution and a second viewpoint image in full resolution; encoding a second partial image including a remaining half of the data of the 3D image; generating streams of the encoded first partial image and the encoded second partial image based on a stream generating method determined from among a first stream generating method that inserts information about the first partial image and information about the second partial image into one stream, and a second stream generating method that inserts the information about the first partial image into a basic layer stream and the information about the second partial image into an enhancement layer stream; and generating an information stream including information indicating the determined stream generating method.

### CROSS-REFERENCE TO RELATED APPLICATIONS

This application is a National Stage Entry of PCT/KR2013/005871, filed on Jul. 2, 2013, which claims priority to U.S. provisional patent application No. 61/667,118, filed on Jul. 2, 2012 in the U.S. Patent and Trademark Office, the entire disclosures of which are incorporated herein by reference in their entirety.

### TECHNICAL FIELD

Apparatuses and methods consistent with exemplary embodiments relate to encoding and decoding video, and more particularly, to generating a 3-dimensional (3D) image data stream for transmitting 3D image data information, and receiving and reproducing the 3D image data stream.

### BACKGROUND OF THE RELATED ART

Recently, as digital image processing and computer graphics technology have developed, research has been actively conducted on three-dimensional (3D) video technology enabling images of the real world to be reproduced and users to realistically experience the reproduced images of the real world.

A 3D image data service is primarily provided via a frame-compatible approach so as to be compatible with legacy receivers. In the frame-compatible approach, original resolutions of left and right images are reduced such that the left and right images are included in one image frame. According to the frame-compatible approach, since an image signal based on an image frame, which is used by a legacy receiver, is used for 3D image data, it is possible to restore left and right images forming a 3D image signal and reproduce the 3D image signal based on the image signal in the frame-compatible approach, which is received from the legacy receiver.

According to developments in hardware and improvements in transmission environments, the 3D image data service is expected to develop into a service capable of providing high resolution 3D image data in the future. However, since the 3D image data service based on the frame-compatible approach transmits two images, e.g., the left and right images, through one image frame, half the data of the original resolution of each of the left and right images is transmitted, and thus, image quality of a 3D image may be relatively low.

### SUMMARY

One or more exemplary embodiments provide a method of providing 3-dimensional (3D) image data that has a high resolution while being compatible with receivers based on a general frame-compatible approach.

According to an aspect of an exemplary embodiment, there is provided a method of generating a 3-dimensional (3D) image data stream, the method including: encoding a first partial image comprising half of data of a 3D image including a first viewpoint image in full resolution and a second viewpoint image in full resolution; encoding a second partial image including a remaining half of the data of the 3D image, the remaining half of the data not being included in the first partial image; generating streams of the encoded first partial image and the encoded second partial image based on a stream generating method determined from among a first stream generating method that inserts information about the first partial image and information about the second partial image into one stream, and a second stream generating method that inserts the information about the first partial image into a basic layer stream and the information about the second partial image into an enhancement layer stream; and generating an information stream including information indicating the determined stream generating method, information indicating whether image data included in a current stream among the generated streams corresponds to the first partial image or the second partial image, and information indicating whether the image data included in the current stream corresponds to the first viewpoint image or the second viewpoint image.

The first partial image and the second partial image may be respectively provided with half of the data of the 3D image according to one of a side-by-side method, a top-bottom method, a column interleaving method, a row interleaving method, a temporal interleaving method, and a checkerboard interleaving method.

The first stream generating method may distinguish the information about the first partial image and the information about the second partial image included in the one stream by using a temporal identifier (ID).

The generating of the information stream may include inserting the information indicating the determined stream generating method, the information indicating whether the image data included in the current stream corresponds to the first partial image or the second partial image, and the information indicating whether the image data included in the current stream corresponds to the first viewpoint image or the second viewpoint image, into a supplemental enhancement information (SEI) message.

The information stream may include, if the current stream is generated based on the first stream generating method, a flag indicating whether to insert the encoded first partial image and the encoded second partial image into different temporal layers that are included in the current stream and distinguished by using a temporal ID, a flag indicating whether data included in the different temporal layers corresponds to the first partial image or the second partial image, and a flag indicating whether the data included in the different temporal layers corresponds to the first viewpoint image or the second viewpoint image.

The information stream may include, if the current stream is generated based on the second stream generating method, a flag indicating whether data included in the current stream corresponds to the first partial image or the second partial image, and a flag indicating whether the data included in the current stream corresponds to the first viewpoint image or the second viewpoint image.

According to another aspect of an exemplary embodiment, there is provided a method of reproducing a 3-dimensional (3D) image data stream, the method including: obtaining a current stream including at least one of a first partial image that includes half of data of a 3D image including a first viewpoint image in full resolution and a second viewpoint image in full resolution, and a second partial image that includes a remaining half of the data of the 3D image, the remaining half of the data not being included in the first partial image; obtaining an information stream including information indicating a stream generating method used to generate the current stream from among a first stream generating method that inserts information about the first partial image and information about the second partial image into one stream, and a second stream generating method that inserts the information about the first partial image into a basic layer stream and the information about the second partial image into an enhancement layer stream, information indicating whether image data included in the current stream corresponds to the first partial image or the second partial image, and information indicating whether the image data included in the current stream corresponds to the first viewpoint image or the second viewpoint image; obtaining the first partial image and the second partial image from the current stream or from the current stream and another stream obtained separately from the current stream, based on the information indicating the stream generating method, the information indicating whether the image data included in the current stream corresponds to the first partial image or the second partial image, and the information indicating whether the image data included in the current stream corresponds to the first viewpoint image or the second viewpoint image, included in the information stream; and reproducing the 3D image in full resolution by using the obtained first partial image and the obtained second partial image.

The first partial image and the second partial image may be respectively provided with half of the data of the 3D image according to one of a side-by-side method, a top-bottom method, a column interleaving method, a row interleaving method, a temporal interleaving method, and a checkerboard interleaving method.

The first stream generating method may distinguish the information about the first partial image and the information about the second partial image included in the one stream by using a temporal identifier (ID).

The information stream may be transmitted through a supplemental enhancement information (SEI) message.

The information stream may include, if the current stream is generated based on the first stream generating method, a flag indicating whether to insert the first partial image and the second partial image into different temporal layers that are included in the current stream and distinguished by using a temporal ID, a flag indicating whether data included in the different temporal layers corresponds to the first partial image or the second partial image, and a flag indicating whether the data included in the different temporal layers corresponds to the first viewpoint image or the second viewpoint image.

The information stream may include, if the current stream is generated based on the second stream generating method, a flag indicating whether data included in the current stream corresponds to the first partial image or the second partial image, and a flag indicating whether the data included in the current stream corresponds to the first viewpoint image or the second viewpoint image.

The reproducing may include: decoding the first viewpoint image in full resolution and the second viewpoint image in full resolution by using the obtained first partial image and the obtained second partial image; and reproducing the 3D image in full resolution by using the decoded first viewpoint image and the decoded second viewpoint image in full resolution.

According to another aspect of an exemplary embodiment, there is provided an apparatus configured to generate a 3-dimensional (3D) image data stream, the apparatus including: a first image encoder configured to encode a first partial image comprising half of data of a 3D image including a first viewpoint image in full resolution and a second viewpoint image in full resolution; a second image encoder configured to encode a second partial image including a remaining half of the data of the 3D image, the remaining half of the data not being included in the first partial image; an image data stream generator configured to generate streams of the encoded first partial image and the encoded second partial image based on a stream generating method determined from among a first stream generating method that inserts information about the first partial image and information about the second partial image into one stream, and a second stream generating method that inserts the information about the first partial image into a basic layer stream and the information about the second partial image into an enhancement layer stream; and an information stream generator configured to generate an information stream comprising information indicating the determined stream generating method, information indicating whether image data included in a current stream among the generated streams corresponds to the first partial image or the second partial image, and information indicating whether the image data included in the current stream corresponds to the first viewpoint image or the second viewpoint image.

According to another aspect of an exemplary embodiment, there is provided an apparatus configured to reproduce a 3-dimensional (3D) image data stream, the apparatus including: an image data stream obtainer configured to obtain a current stream including at least one of a first partial image that includes half of data of a 3D image including a first viewpoint image in full resolution and a second viewpoint image in full resolution, and a second partial image that includes a remaining half of the data of the 3D image, the remaining half of the data not being included in the first partial image; an information stream obtainer configured to obtain an information stream including information indicating a stream generating method used to generate the current stream from among a first stream generating method that inserts information about the first partial image and information about the second partial image into one stream, and a second stream generating method that inserts the information about the first partial image into a basic layer stream and the information about the second partial image into an enhancement layer stream, information indicating whether image data included in the current stream corresponds to the first partial image or the second partial image, and information indicating whether the image data included in the current stream corresponds to the first viewpoint image or the second viewpoint image; an image decoder configured to obtain the first partial image and the second partial image from the current stream or from the current stream and another stream obtained separately from the current stream, based on the information indicating the stream generating method, the information indicating whether the image data included in the current stream corresponds to the first partial image or the second partial image, and the information indicating whether the image data included in the current stream corresponds to the first viewpoint image or the second viewpoint image, included in the obtained information stream, and decode the obtained first partial image and the obtained second partial image; and a 3D image de-multiplexer configured to generate the 3D image in full resolution by reconstructing the decoded first partial image and the decoded second partial image based on the information indicating the stream generating method, the information indicating whether the image data included in the current stream corresponds to the first partial image or the second partial image, and the information indicating whether the image data included in the current stream corresponds to the first viewpoint image or the second viewpoint image, included in the obtained information stream.

According to one or more exemplary embodiments, 3-dimensional (3D) image data which has a high resolution and which is compatible with legacy receivers may be provided. According to one or more exemplary embodiments, the legacy receivers reproduce 3D image data according to a general method, and if the legacy receivers are capable of reproducing 3D image data having high resolution based on performance of the legacy receivers, the legacy receivers receive and reproduce the high resolution 3D image data.

### BRIEF DESCRIPTION OF THE DRAWINGS

FIG. 1 is a block diagram of an apparatus for generating a 3-dimensional (3D) image data stream, according to an exemplary embodiment;

FIG. 2 is a diagram for describing the operation of generating a basic layer image and an enhancement layer image based on a 3D image in full resolution, by using a side-by-side method, according to an exemplary embodiment;

FIG. 3 is a diagram for describing the operation of generating a basic layer image and an enhancement layer image based on a 3D image in full resolution, by using a temporal interleaving method, according to an exemplary embodiment;

FIG. 4 is a diagram for describing the operation of generating a basic layer 3D image and an enhancement layer 3D image based on a 3D image in full resolution, by using a top-bottom method, according to an exemplary embodiment;

FIG. 5 illustrates a stream generated based on a first stream generating method according to an exemplary embodiment, wherein the stream includes information about a basic layer image and an enhancement layer image;

FIG. 6 illustrates a basic layer stream including information about a basic layer image and an enhancement layer stream including information about an enhancement layer image, which are generated based on a second stream generating method according to an exemplary embodiment;

FIG. 7 illustrates information included in an information stream, according to an exemplary embodiment;

FIG. 8 is a flowchart of a method of generating a 3D image data stream, according to an exemplary embodiment;

FIG. 9 is a block diagram of an apparatus for reproducing a 3D image data stream, according to an exemplary embodiment;

FIG. 10 is a diagram for describing a process of reproducing a 3D image data stream, according to an exemplary embodiment;

FIG. 11 is a flowchart of a method of reproducing a 3D image data stream, according to an exemplary embodiment;

FIG. 12 is a block diagram of a video encoding apparatus configured to encode video using video prediction based on coding units having a tree structure, according to an exemplary embodiment;

FIG. 13 is a block diagram of a video decoding apparatus configured to decode video using video prediction based on coding units having a tree structure, according to an exemplary embodiment;

FIG. 14 illustrates a concept of coding units according to an exemplary embodiment;

FIG. 15 is a block diagram of an image encoder configured to encode images based on coding units, according to an exemplary embodiment;

FIG. 16 is a block diagram of an image decoder configured to decode images based on coding units, according to an exemplary embodiment;

FIG. 17 is a diagram illustrating coding units corresponding to depths, and partitions, according to an exemplary embodiment;

FIG. 18 is a diagram illustrating a relationship between a coding unit and transformation units, according to an exemplary embodiment;

FIG. 19 is a diagram illustrating encoding information corresponding to depths, according to an exemplary embodiment;

FIG. 20 is a diagram illustrating coding units corresponding to depths, according to an exemplary embodiment;

FIGS. 21, 22, and 23 are diagrams illustrating a relationship between coding units, prediction units, and transformation units, according to an exemplary embodiment; and

FIG. 24 is a diagram illustrating a relationship between a coding unit, a prediction unit, and a transformation unit, according to encoding mode information of Table 1.

### DETAILED DESCRIPTION OF EXEMPLARY EMBODIMENTS

Hereinafter, exemplary embodiments will be described in detail with reference to the appended claims.

Herein, a 3-dimensional (3D) image may denote image data including a left viewpoint image and a right viewpoint image, or may denote one image including information about both the left viewpoint image and the right viewpoint image based on a frame-compatible approach. Also, one of the left viewpoint image and the right viewpoint image may also be referred to as a first viewpoint image and the other one may also be referred to as a second viewpoint image. Also, full resolution may denote original resolution of an input image.

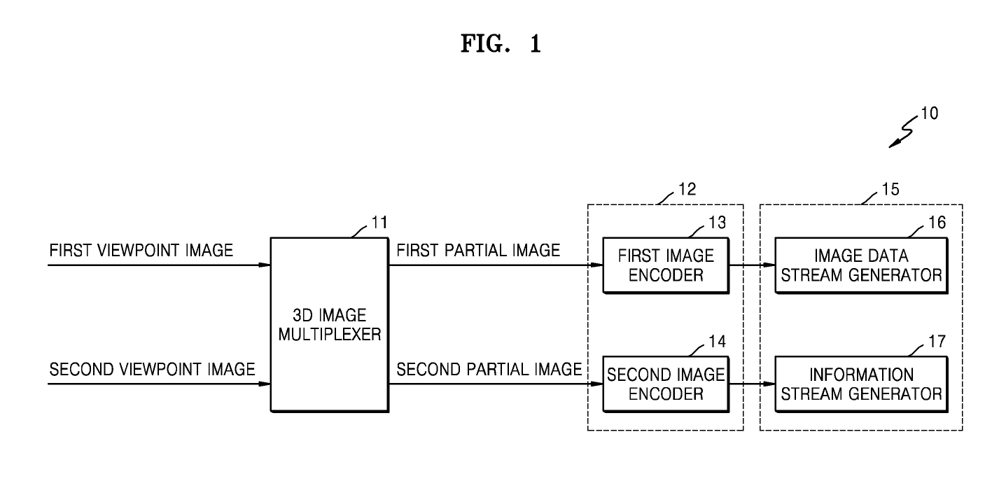

FIG. 1 is a block diagram of an apparatus 10 for generating a 3D image data stream, according to an exemplary embodiment.

Referring to FIG. 1, the apparatus 10 according to an exemplary embodiment includes a 3D image multiplexer 11, an image encoder 12, and a stream generator 15.

The 3D image multiplexer 11 generates a basic layer image including half of data (hereinafter also referred to as “half data”) of a 3D image including a left viewpoint image in full resolution and a right viewpoint image in full resolution, and an enhancement layer image including the remaining half data of the 3D image, which is not included in the basic layer image.

The image encoder 12 includes a first image encoder 13 that encodes the basic layer image and a second image encoder 14 that encodes the enhancement layer image. The basic layer image denotes a first partial image including the half data of the 3D image including the left viewpoint image in full resolution and the right viewpoint image in full resolution. The basic layer image may be generated based on a frame-compatible approach. The enhancement layer image denotes a second partial image including the remaining half data of the 3D image, which is not included in the basic layer image, e.g., the first partial image.

The stream generator 15 includes an image data stream generator 16 and an information stream generator 17. The image data stream generator 16 generates a data stream of 3D image data based on a stream generating method determined from among a first stream generating method that adds information about the basic layer image and the enhancement layer image to one stream and a second stream generating method that adds information about the basic layer image to a basic layer stream and information about the enhancement layer image to an enhancement layer stream. The basic layer image and the enhancement layer image added to the one stream based on the first stream generating method may be distinguished through a temporal identifier temporal_id.

The information stream generator 17 generates an information stream including information about the stream generating method determined by the image data stream generator 16, information about whether image data included in a current stream corresponds to the first partial image or the second partial image, and information about whether the image data included in the current stream corresponds to the first viewpoint image and the second viewpoint image.

A method of generating, by the apparatus 10 of FIG. 1, a 3D image data stream will now be described in detail.

The 3D image multiplexer 11 generates a basic layer image frame by selecting half data of a left viewpoint image frame in full resolution and half data of a right viewpoint image frame in full resolution according to one of several types of frame packing arrangement (FPA) methods, such as a side-by-side method, a top-bottom method, a column interleaving method, a row interleaving method, a temporal interleaving method, and a checkerboard interleaving method. Also, the 3D image multiplexer 11 generates an enhancement layer image frame by using the remaining half data of the left viewpoint image frame in full resolution and the remaining half data of the right viewpoint image frame in full resolution, which are not included in the basic layer image frame.

Information about an FPA is information about a method of constructing 3D image data, and may include information about how to form a 3D image by using image data included in a 3D image data stream received by a receiver (or a reproducer) that receives a 3D image stream. Such information about an FPA may be included in an FPA supplemental enhancement information (SEI) message in an SEI message. The information about an FPA included in the SEI message will be described in detail later.

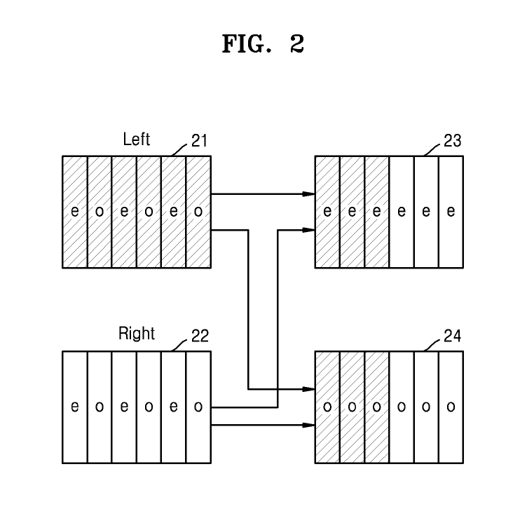

FIG. 2 is a diagram for describing generating a basic layer image 23 and an enhancement layer image 24 based on a 3D image in full resolution, by using a side-by-side method, according to an exemplary embodiment.

Referring to FIG. 2, the 3D image multiplexer 11 combines a left viewpoint image 21 in full resolution and a right viewpoint image 22 in full resolution to generate the basic layer image 23 including half data of the left viewpoint image 21 and half data of the right viewpoint image 22, and the enhancement layer image 24 including the remaining half data of the left viewpoint image 21 and the remaining half data of the right viewpoint image 22.

In detail, when the side-by-side method is used, the 3D image multiplexer 11 generates the basic layer image 23 by using data of even columns e of the left viewpoint image 21 and data of even columns e of the right viewpoint image 22, and generates the enhancement layer image 24 by using data of odd columns o of the left viewpoint image 21 and data of odd columns o of the right viewpoint image 22. If the original resolution of each of the left and right viewpoint images 21 and 22 is 1920×1080, the resolution of each of the basic layer image 23 and the enhancement layer image 24 is also 1920×1080. Each of the basic layer image 23 and the enhancement layer image 24 includes half data of the left viewpoint image 21 and half data of the right viewpoint image 22.

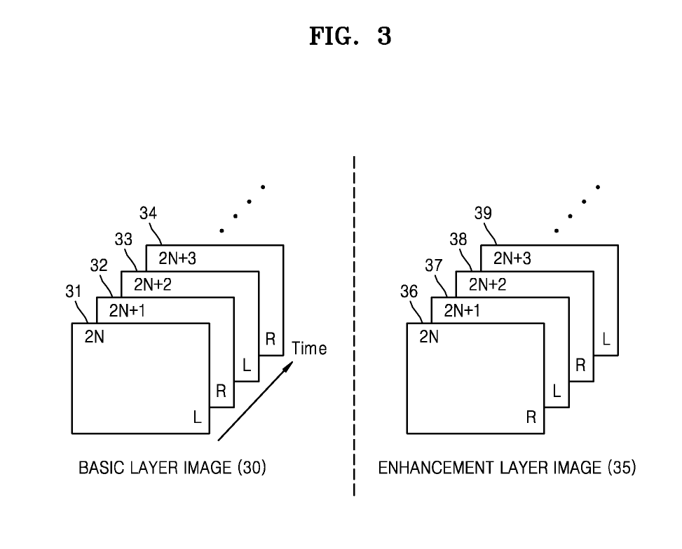

FIG. 3 is a diagram for describing generating a basic layer image and an enhancement layer image based on a 3D image in full resolution, by using a temporal interleaving method, according to an exemplary embodiment.

In a temporal interleaving method, a left viewpoint image in full resolution and a right viewpoint image in full resolution are alternately arranged. In other words, according to the temporal interleaving method, one of a left viewpoint image and a right viewpoint image, which are input at one point of time, is selected and the left viewpoint image and the right viewpoint image are alternately arranged according to a chronological order.

Based on such a temporal interleaving method, the 3D image multiplexer 11 may generate a basic layer image by selecting a viewpoint image from among a left viewpoint image in full resolution and a right viewpoint image in full resolution, which are input at the same time, and generate an enhancement layer image by selecting the other viewpoint image that is not included in the basic layer image.

Referring to FIG. 3, based on the temporal interleaving method, the 3D image multiplexer 11 determines a left viewpoint image 31 in full resolution input at a time 2N as a basic layer image 30, and determines a right viewpoint image 36 in full resolution input at the time 2N as an enhancement layer image 35. Similarly, the 3D image multiplexer 11 determines a right viewpoint image 32 in full resolution input at a time (2N+1) as the basic layer image 30, and determines a left viewpoint image 37 in full resolution input at the time (2N+1) as the enhancement layer image 35. Also, the 3D image multiplexer 11 determines a left viewpoint image 33 in full resolution input at a time (2N+2) as the basic layer image 30, and determines a right viewpoint image 38 in full resolution input at the time (2N+2) as the enhancement layer image 35. Also, the 3D image multiplexer 11 determines a right viewpoint image 34 in full resolution input at a time (2N+3) as the basic layer image 30, and determines a left viewpoint image 39 in full resolution input at the time (2N+3) as the enhancement layer image 35.

As such, when the temporal interleaving method is used, the 3D image multiplexer 11 determines and outputs one of a left viewpoint image and a right viewpoint image input at the same time as a basic layer image, and the other one as an enhancement layer image. Even when the temporal interleaving method is used, each of the basic layer image and the enhancement layer image includes data of one of the left viewpoint image and the right viewpoint image, and thus, the basic layer image and the enhancement layer image based on the temporal interleaving method each include half data compared to original 3D image data.

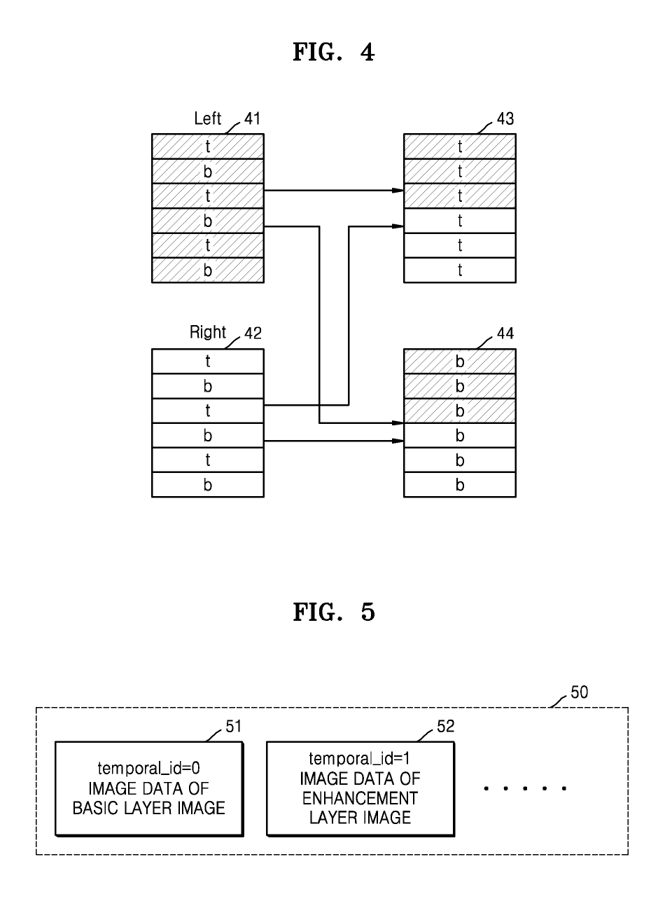

FIG. 4 is a diagram for describing the operation of generating a basic layer 3D image and an enhancement layer 3D image based on a 3D image in full resolution, by using a top-bottom method, according to an exemplary embodiment.

Referring to FIG. 4, the 3D image multiplexer 11 combines a left viewpoint image 41 in full resolution and right viewpoint image 42 in full resolution to generate a basic layer image 43 including half data of the left viewpoint image 41 and half data of the right viewpoint image 42, and an enhancement layer image 44 including the remaining half data of the left viewpoint image 41 and the remaining half data of the right viewpoint image 42, which are not included in the basic layer image 43.

In detail, when the top-bottom method is used, the 3D image multiplexer 11 generates the basic layer image 43 by using data of even rows t of the left viewpoint image 41 and data of even rows t of the right viewpoint image 42, and generates the enhancement layer image 44 by using data of odd rows b of the left viewpoint image 41 and data of odd rows b of the right viewpoint image 42. If original resolution of each of the left and right viewpoint images 41 and 42 is 1920×1080, resolution of each of the basic layer image 43 and the enhancement layer image 44 is also 1920×1080. Each of the basic layer image 43 and the enhancement layer image 44 includes ½ data of the left viewpoint image 41 and ½ data of the right viewpoint image 42.

The 3D image multiplexer 11 generates and outputs a basic layer image including half data of a left viewpoint image in full resolution and half data of a right viewpoint image in full resolution, and an enhancement layer image including the remaining half data of the left viewpoint image and the remaining half data of the right viewpoint image, which are not included in the basic layer image, by using any one of a column interleaving method, a row interleaving method, and a checkerboard interleaving method, as well as the side-by-side method, the temporal interleaving method, and the top-bottom method described above.

As will be described later, if only a basic layer stream is received and decoded by a receiver, a left viewpoint image and a right viewpoint image are extracted from a basic layer image and then the left and right viewpoint images are restored to full resolution via up-conversion. If a 3D image is restored by only using the basic layer image, the left and right viewpoint images in full resolution, which are restored through the up-conversion, are obtained by restoring lost image components, and thus image quality deterioration is inevitable compared to the left and right viewpoint images in original full resolution. Thus, according to one or more exemplary embodiments, an enhancement layer stream including the remaining half data that is not included in the basic layer stream is used. If the receiver receives the enhancement layer stream as well as the basic layer stream, the receiver may restore the 3D image in full resolution without having to perform up-conversion, by combining a 3D image included in the basic layer stream and a 3D image included in the enhancement layer stream. If the receiver is able to restore only the basic layer stream even if the basic layer stream and the enhancement layer stream are both received, the receiver restores and reproduces the 3D image by only using the basic layer stream. On the other hand, if the receiver is able to also process the enhancement layer stream, the receiver may restore and reproduce the 3D image by using both the basic layer stream and the enhancement layer stream. An apparatus for receiving and reproducing a 3D image data stream will be described later.

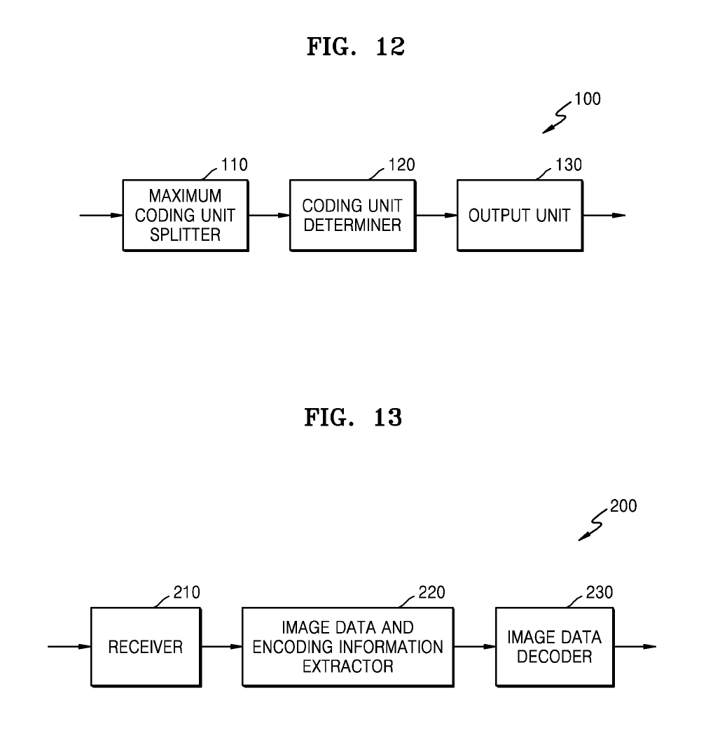

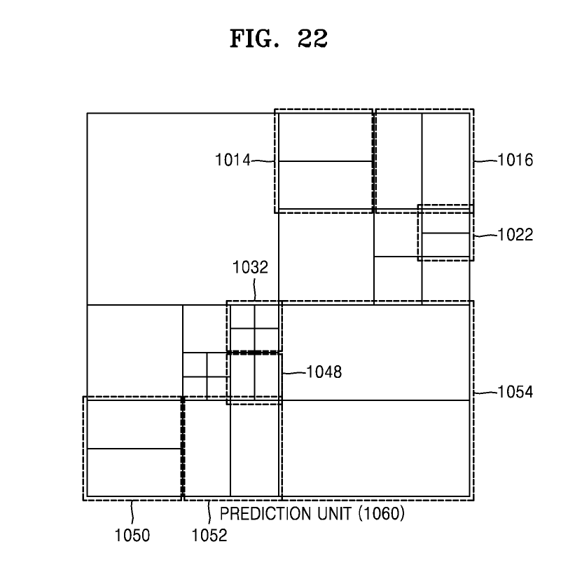

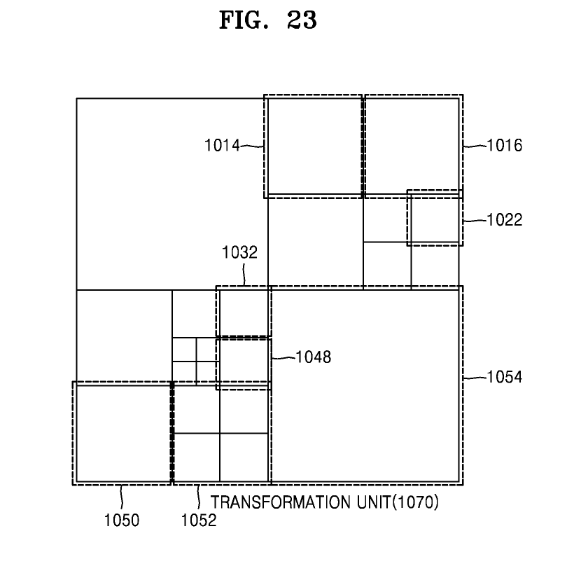

Referring back to FIG. 1, the first image encoder 13 encodes the basic layer image output from the 3D image multiplexer 11. The second image encoder 14 encodes the enhancement layer image output from the 3D image multiplexer 11. The first and second image encoder 13 and 14 may encode an image based on any one of various image compression methods, such as MPEG-2, MPEG-4, H.264/AVC, and high efficiency video coding (HEVC). In order to be compatible with any widely used receiver, the first image encoder 13 may encode the basic layer image via MPEG-2, MPEG-4, or H.264/AVC. A method of encoding an image based on HEVC will be described later with reference to FIGS. 12 through 24. However, a method of encoding an image, which is performed by the first and second image encoders 13 and 14, is not limited thereto, and any one of various image compression methods may be used.

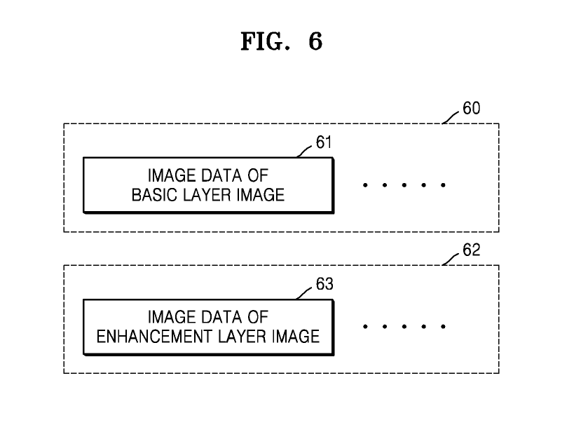

FIG. 5 illustrates a stream 50 generated based on a first stream generating method according to an exemplary embodiment, wherein the stream 50 includes information about a basic layer image and an enhancement layer image, and FIG. 6 illustrates a basic layer stream 60 including information about a basic layer image and an enhancement layer stream 62 including information about an enhancement layer image, which are generated based on a second stream generating method according to an exemplary embodiment.

Referring to FIGS. 1 and 5, the image data stream generator 16 may insert the information about the basic layer image and the enhancement layer image into the stream 50 according to the first stream generating method. Whether image data 51 and 52 included in the stream 50 is a basic layer image or an enhancement layer image may be determined by using a temporal identifier temporal_id. For example, the image data stream generator 16 may include a temporal identifier temporal_id having a value of 0 with image data 51 obtained by encoding the basic layer image, and may include a temporal identifier temporal_id having a value of 1 with image data 52 obtained by encoding the enhancement layer image. Each of the image data 51 and 52 included in the stream 50 may be provided in an access unit (AU). In other words, the image data 51 and 52 included in the stream 50 may be image data generated in a frame unit. In other words, the image data 51 and 52 included in the stream 50 may each be image data obtained by encoding one sheet of a first partial image or one sheet of a second partial image.

Referring to FIGS. 1 and 6, the image data stream generator 16 may add image data 61 of a basic layer image to the basic layer stream 60, and image data 63 of an enhancement layer image to the enhancement layer stream 62, according to the second stream generating method. The image data 61 and 63 respectively included in the basic layer stream 60 and the enhancement layer stream 62 may also be respectively provided in one AU.

The information stream generator 17 generates an information stream including information about a stream generating method used to generate a current stream from among the first and second stream generating methods, information about whether image data included in the current stream corresponds to a first partial image that is the basic layer image or a second partial image that is the enhancement layer image, and information about whether the image data included in the current stream corresponds to a first viewpoint image or a second viewpoint image. The information included in the information stream is information for forming a 3D image after image decoding, and is not information directly used to decode image data. Thus, the information stream may be transmitted through an SEI image separately from an image data stream. The SEI message may be provided in an SEI network adaptive layer (NAL) unit, and may be provided in an AU to be transmitted together with encoded image data.

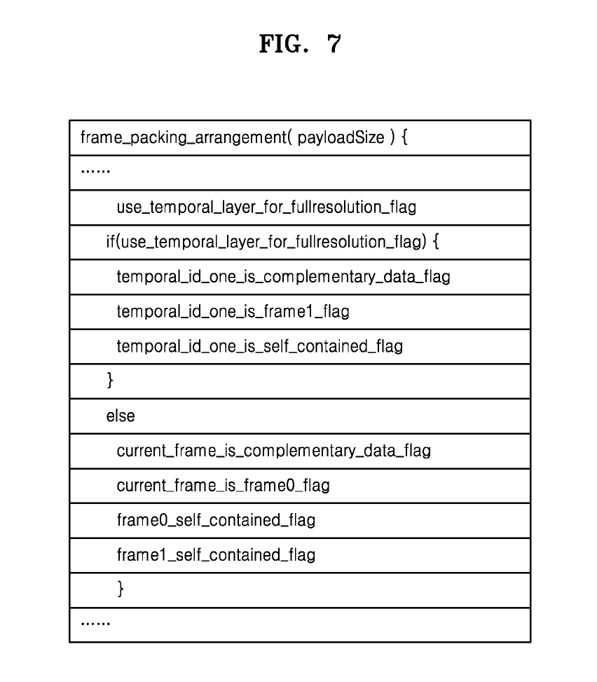

FIG. 7 illustrates information included in an information stream, according to an exemplary embodiment.

The information stream may include information about an FPA. As described above, the information about an FPA is information about a method of configuring 3D image data, and may include information about how to form a 3D image by using image data included in a 3D image stream received from a receiver (or a reproducer) that receives the 3D image stream.

Referring to FIG. 7, the information about an FPA included in an SEI message includes a flag ‘use_temporal_layer_for_fullresolution_flag’ indicating information about a stream generating method used to generate a current image data stream from among the first and second stream generating methods. If the flag ‘use_temporal_layer_for_fullresolution_flag’ is 1, image data of a basic layer image and image data of an enhancement layer image are included in the current image data stream according to the first stream generating method. As described above, the basic layer image and the enhancement layer image included in the current image data stream may be distinguished by using a temporal identifier temporal_id. In other words, if the flag ‘use_temporal_layer_for_fullresolution_flag’ is 1, image data having 0 as a temporal identifier temporal_id may be identified as the image data of the basic layer image and image data having 1 as a temporal identifier temporal_id may be identified as the image data of the enhancement layer image, or vice versa.

If the flag ‘use_temporal_layer_for_fullresolution_flag’ is 0, the image data of the basic layer image may be included in a basic layer stream and the image data of the enhancement layer image may be included in an enhancement layer stream.

In FIG. 7, as indicated by a pseudo code ‘if(use_temporal_layer_for_fullresolution_flag)’, if the flag ‘use_temporal_layer_for_fullresolution_flag’ is 1, e.g., if it is determined that the image data of the basic layer image and the image data of the enhancement layer image are included in the current image data stream according to the first stream generating method, a flag ‘temporal_id_one_is_complementary_data_flag’ indicating whether the image data having 1 as the temporal identifier temporal_id is the image data of the enhancement layer image may be set. If the flag ‘temporal_id_one_is_complementary_data_flag’ is 1, the image data having 1 as the temporal identifier temporal_id is the image data of the enhancement layer image. If the flag ‘temporal_id_one_is_complementary_data_flag’ is 1, the image data having 1 as the temporal identifier temporal_id is image data of an enhancement layer image corresponding to image data of a basic layer image, which has 0 as the temporal identifier temporal_id. If the flag ‘temporal_id_one_is_complementary_data_flag’ is 0, the image data having 1 as the temporal identifier temporal_id is related to data at the leftmost top of an original image. If a 3D image is arranged according to a temporal interleaving method, the flag ‘temporal_id_one_is_complementary_data_flag’ is set to 0.

As described above with reference to FIG. 3, when the temporal interleaving method is used, image data included in an image data stream is related to one of a left viewpoint image and a right viewpoint image. Accordingly, a flag ‘temporal_id_one_is_frame1_flag’ indicating whether image data included in an image data stream encoded based on the temporal interleaving method is a left viewpoint image or a right viewpoint image may be set. If one of a left viewpoint image and a right viewpoint image to be displayed at the same time is referred to as a frame 0 and the other one is referred to as a frame 1, the flag ‘temporal_id_one_is_frame1_flag’ indicates whether the image data having 1 as the temporal identifier temporal_id corresponds to the frame 1. In detail, if the flag ‘temporal_id_one_is_frame1_flag’ is 1, the image data having 1 as the temporal identifier temporal_id corresponds to the frame 1, and image data having 0 as a temporal identifier temporal_id and pre-decoded corresponds to the frame 0. A display time of the frame 0 that is pre-decoded is delayed so as to be simultaneously displayed with the frame 1. If the flag ‘temporal_id_one_is_frame1_flag’ is 0, the image data having 1 as the temporal identifier temporal_id corresponds to the frame 0, and the image data having 0 as the temporal identifier temporal_id and pre-decoded corresponds to the frame 1. Considering that the image data stream includes image data encoded in an order of the frame 0 and the frame 1, if the flag ‘temporal_id_one_is_frame1_flag’ is 0, the display time of the frame 0 that is pre-decoded is not delayed to be simultaneously displayed with the frame 1 that is currently decoded.

The information about an FPA, which is included in the SEI message, may include a flag ‘temporal_id_one_is_self contained_flag’ indicating an inter-prediction relationship between the image data having 0 as the temporal identifier temporal_id and the image data having 1 as the temporal identifier temporal_id. If the flag ‘temporal_id_one_is_self_contained_flag’ is 1, inter-prediction may be performed on the image data having 0 as the temporal identifier temporal_id and the image data having 1 as the temporal identifier temporal_id during a decoding process, and if the flag ‘temporal_id_one_is_self_contained_flag’ is 0, the inter-prediction may not be performed.

As described above, if the flag ‘use_temporal_layer_for_fullresolution_flag’ is 0, the image data of the basic layer image is included in the basic layer stream and the image data of the enhancement layer image is included in the enhancement layer stream according to the second stream generating method. As described above with reference to FIG. 6, an image data stream generated according to the second stream generating method may be one of the basic layer stream including the image data of the basic layer image and the enhancement layer stream including the image data of the enhancement layer image. Accordingly, information should be provided to signal whether the current image data stream corresponds to the basic layer stream or the enhancement layer stream to a receiver. Accordingly, the information about an FPA, which is included in the SEI message, may include a flag ‘current_frame_is_complementary_data_flag’ indicating whether the current image data stream corresponds to the basic layer stream or the enhancement layer stream. If the flag ‘current_frame_is_complementary_data_flag’ is 1, the current image data stream is the enhancement layer stream including the image data of the enhancement layer image, and image data received separately from the current image data stream is the basic layer stream including the image data of the basic layer image. In other words, if the flag ‘current_frame_is_complementary_data_flag’ is 1, an image included in the current image data stream corresponds to an enhancement layer image with respect to a basic layer image that is included in another image data stream and has the same picture order count (POC).

If the current image data stream is generated according to the second stream generating method and the temporal interleaving method, the information about an FPA, which is included in the SEI message, includes a flag ‘current_frame_is_frame0_flag’ indicating whether image data included in the current image data corresponds to a left viewpoint image or a right viewpoint image. If the flag ‘current_frame_is_frame0_flag’ is 1, the image data included in the current image data stream corresponds to the frame 0, and image data of the same POC included in another image data stream corresponds to the frame 1. If the flag ‘current_frame_is_frame0_flag’ is 0, the image data included in the current image data stream corresponds to the frame 1, and the image data of the same POC included in the other image data stream corresponds to the frame 0.

A flag ‘frame_packing_arrangement_type’ indicating information about a method applied to an image included in a current stream, from among various frame packing methods, such as a side-by-side method, a top-bottom method, a column interleaving method, a row interleaving method, a temporal interleaving method, and a checkerboard interleaving method, may also be included in and transmitted with the information stream.

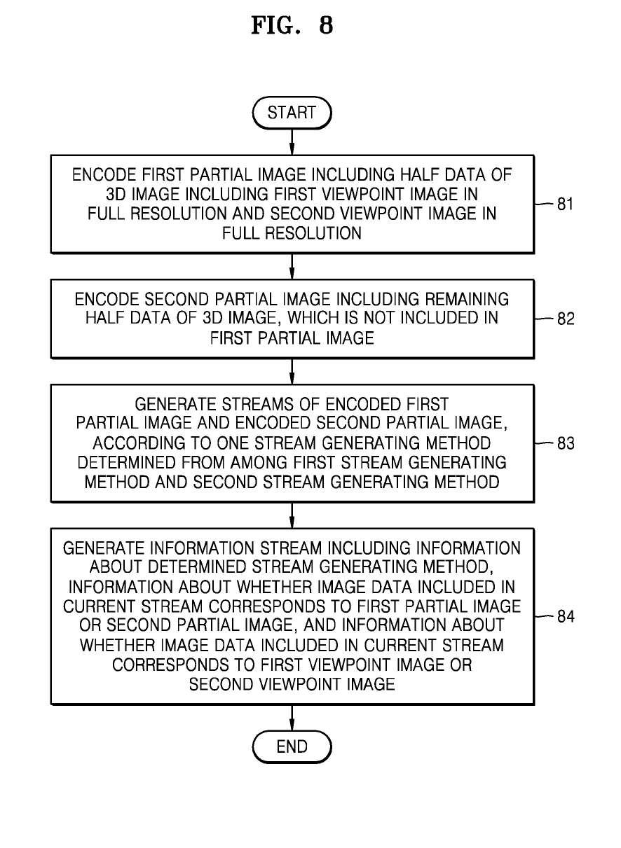

FIG. 8 is a flowchart of a method of generating a 3D image data stream, according to an exemplary embodiment.

Referring to FIGS. 1 and 8, in operation 81, the first image encoder 13 encodes a first partial image including half data of a 3D image including a first viewpoint image in full resolution and a second viewpoint image in full resolution.

In operation 82, the second image encoder 14 encodes a second partial image including the remaining half data of the 3D image, which is not included in the first partial image.

As described above, the first partial image corresponds to a basic layer image that is generated by the 3D image multiplexer 11 by selecting half data of the left viewpoint image in full resolution and half data of the right viewpoint image in full resolution, according to one FPA method from among a side-by-side method, a top-bottom method, a column interleaving method, a row interleaving method, a temporal interleaving method, and a checkerboard interleaving method. Also, the second partial image corresponds to an enhancement layer image that is generated by the 3D image multiplexer 11 by using the remaining half data of the left viewpoint image in full resolution and the remaining half data of the right viewpoint image in full resolution, which are not included in the basic layer image.

In operation 83, the image data stream generator 16 generates streams of the encoded first partial image and the encoded second partial image based on a stream generating method determined from among a first stream generating method that inserts information about the first partial image and the second partial image into one stream, and a second stream generating method that inserts the information about the first partial image into a basic layer stream and the information about the second partial image into an enhancement layer stream. As described above, whether image data included in an image data stream corresponds to a basic layer image or an enhancement layer image is determined by using a temporal identifier temporal_id. In other words, image data having 0 as a temporal identifier temporal_id is image data of the basic layer image, and image data having 1 as a temporal identifier temporal_id is image data of the enhancement layer image.

In operation 84, the information stream generator 17 generates an information stream including information about the determined stream generating method and information about whether image data included in a current stream corresponds to the first partial image or the second partial image and about whether the image data included in the current stream corresponds to the first viewpoint image or the second viewpoint image.

As described above, if the current stream is generated according to the first stream generating method, the information stream may include a flag ‘use_temporal_layer_for_fullresolution_flag’ indicating whether to insert the encoded first partial image and the encoded second partial image into different temporal layers that are included in the current stream and distinguished by using a temporal identifier temporal_id, a flag ‘temporal_id_one_is_complimentary_data_flag’ indicating whether data included in the different temporal layers corresponds to the first partial image or the second partial image, and a flag ‘temporal_id_one_is_frame1_flag’ indicating whether the data included in the different temporal layers corresponds to the first viewpoint image or the second viewpoint image.

If the current stream is generated based on the second stream generating method, e.g., if the flag ‘use_temporal_layer_for_fullresolution_flag’ is 0, the information stream may include a flag ‘current_frame_is_complementary_data_flag’ indicating whether data included in the current stream corresponds to the first partial image or the second partial image, and a flag ‘current_frameis_frame0_flag’ indicating whether the data included in the current stream corresponds to the first viewpoint image or the second viewpoint image. Such an information stream may be generated in a form of an SEI message.

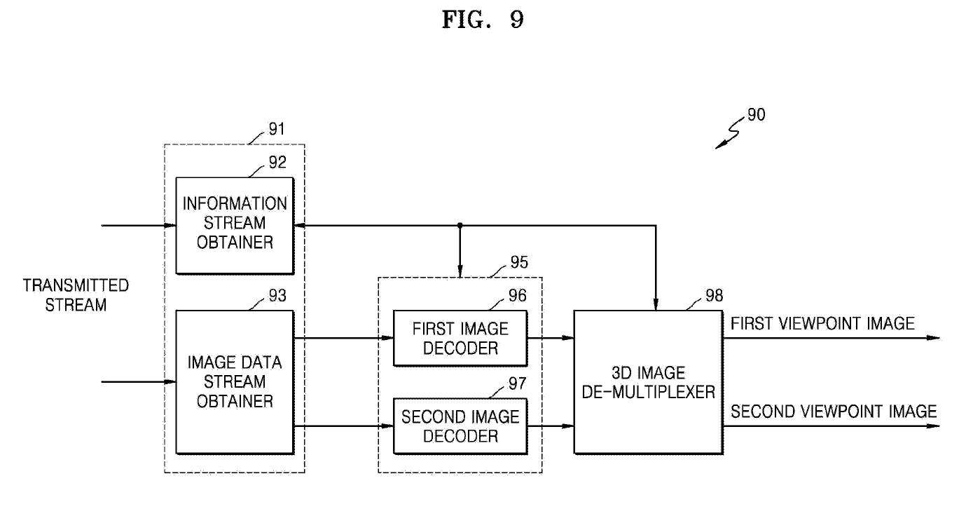

FIG. 9 is a block diagram of an apparatus 90 for reproducing a 3D image data stream, according to an exemplary embodiment.

Referring to FIG. 9, the apparatus 90 includes a stream obtainer 91, an image decoder 95, and a 3D image de-multiplexer 98.

The stream obtainer 91 includes an information stream obtainer 92 and an image data stream obtainer 93. The image data stream obtainer 93 obtains an image data stream including at least one of a first partial image that includes half data of a 3D image including a first viewpoint image in full resolution and a second viewpoint image in full resolution, and a second partial image that includes the remaining half data of the 3D image, which is not included in the first partial image. As described above, the image data stream encoded according to the first stream generating method includes both information about the encoded first partial image and information about the encoded second partial image. The image data stream encoded according to the second stream generating method corresponds to one of a basic layer stream including the first partial image and an enhancement layer stream including the second partial image.

The information stream obtainer 92 obtains an information stream including information about a stream generating method used for a current image data stream received from the image data stream obtainer 93, information about whether image data included in the current image data stream corresponds to the first partial image or the second partial image, and information about whether the image data included in the current image data stream corresponds to a first viewpoint image or a second viewpoint image.

The information stream may also include the flag ‘frame_packing_arrangement_type’ indicating information about a method applied to an image include in the current image data stream, from among various frame packing methods, such as a side-by-side method, a top-bottom method, a column interleaving method, a row interleaving method, a temporal interleaving method, and a checkerboard interleaving method.

The information stream obtainer 92 may obtain FPA information that is information about a method of constructing 3D image data through an SEI message, as described above with reference to FIG. 7.

The stream generating method applied to a current image data stream received by the image data stream obtainer 93 may be determined by using the flag ‘use_temporal_layer_for_fullresolution_flag’ included in the information stream. If the flag ‘use_temporal_layer_for_fullresolution_flag’ is 1, the image data of both the basic layer image and the enhancement layer image are included in the current image data stream based on the first stream generating method. As described above, a basic layer image and an enhancement layer image included in one image data stream may be distinguished by using a temporal identifier temporal_id. If the flag ‘use_temporal_layer_for_fullresolution_flag’ is 0, the current image data stream is generated based on the second stream generating method.

If the flag ‘use_temporal_layer_for_fullresolution_flag’ is 1, e.g., if the image data of both the basic layer image and the enhancement layer image are included in the current image data stream based on the first stream generating method, it may be determined whether image data having 1 as a temporal identifier temporal_id from among the image data included in the current image data stream is the image data of the enhancement layer image by using the flag ‘temporal_id_one_is_complementary_data_flag’. If the flag ‘temporal_id_one_is_complementary_data_flag’ is 1, the image data having 1 as the temporal identifier temporal_id is the image data of the enhancement layer image. If the flag ‘temporal_id_one_is_complementary_data_flag’ is 1, the image data having 1 as the temporal identifier temporal_id is image data of an enhancement layer image corresponding to image data of a previous basic layer having 0 as a temporal identifier temporal_id. If the flag ‘temporal_id_one_is_complementary_data_flag’ is 0, the image data having 1 as the temporal identifier temporal_id is related to data located at the leftmost top of an original image.

As described above with reference to FIG. 3, when a temporal interleaving method is used, image data included in an image data stream is related to one of a left viewpoint image and a right viewpoint image. Accordingly, regarding an image data stream encoded based on a temporal interleaving method, the information stream may include the flag ‘temporal_id_one_is_frame1_flag’ indicating whether image data included in the image data stream corresponds to a left viewpoint image or a right viewpoint image. If a frame 0 denotes one of a left viewpoint image and a right viewpoint image, which are to be displayed at the same time, and a frame 1 denotes the other one of the left viewpoint image and the right viewpoint image, the flag ‘temporal_id_one_is_frame1_flag’ indicates whether image data having 1 as a temporal identifier temporal_id corresponds to the frame 1. In detail, if the flag ‘temporal_id_one_is_frame1_flag’ is 1, the image data having 1 as the temporal identifier temporal_id corresponds to the frame 1, and image data pre-decoded and having 0 as a temporal identifier temporal_id corresponds to the frame 0. If the flag ‘temporal_id_one_is_frame1_flag’ is 0, the image data having 1 as the temporal identifier temporal_id corresponds to the frame 0 and the image data pre-decoded and having 0 as the temporal identifier temporal_id corresponds to the frame 1.

As described above, if the flag ‘use_temporal_layer_for_fullresolution_flag’ is 0, the current image data stream is generated based on the second stream generating method and is one of a basic layer stream and an enhancement layer stream. Whether the current image data stream generated based on the second stream generating method corresponds to the basic layer stream or the enhancement layer stream may be determined by using the flag ‘current_frame_is_complementary_data_flag’.

If the flag ‘current_frame_is_complementary_data_flag’ is 1, the current image data stream is the enhancement layer stream including the enhancement layer image, and an image data stream received separately from the current image data stream is the basic layer stream including the basic layer image. In other words, if the flag ‘current_frame_is_complementary_data_flag’ is 1, an image included in the current image data stream corresponds to an enhancement layer image with respect to a basic layer image that is included in the other image data stream and has the same POC.

Alternatively, if the current image data stream is generated based on the second stream generating method and the temporal interleaving method, information about an FPA included in an SEI message includes the flag ‘current_frame_is_frame0_flag’ indicating whether the image data included in the current image data stream corresponds to the left viewpoint image or the right viewpoint image. If the flag ‘current_frame_is_frame0_flag’ is 1, the image data included in the current image data stream corresponds to the frame 0, and image data included in the other image data stream and having the same POC corresponds to the frame 1. If the flag ‘current_frame_is_frame0_flag’ is 0, the image data included in the current image data stream corresponds to the frame 1, and the image data included in the other image data stream and having the same POC corresponds to the frame 0.

The image decoder 95 may obtain the first partial image and the second partial image from the current image data stream generated based on the first stream generating method, based on the information included in the information stream obtained from the information stream obtainer 92. If the current image data stream is generated based on the second stream generating method, the image decoder 95 may obtain the first partial image and the second partial image from the current image data stream and the other image data stream obtained separately from the current image data stream. A first image decoder 96 of the image decoder 95 decodes the first partial image and a second image decoder 97 of the image decoder 95 decodes the second partial image.

The 3D image de-multiplexer 98 generates the 3D image in full resolution by reconstructing the first and second partial images decoded based on the information included in the information stream.

If only the basic layer stream is received and decoded, the apparatus 90 according to an exemplary embodiment extracts the left viewpoint image and the right viewpoint image from the basic layer image and restores the left viewpoint image in full resolution and the right viewpoint image in full resolution via up-conversion. If the apparatus 90 also receives the enhancement layer stream as well as the basic layer stream, the apparatus 90 may restore the 3D image in full resolution without having to perform up-conversion, by combining a 3D image included in the basic layer stream and a 3D image included in the enhancement layer stream.

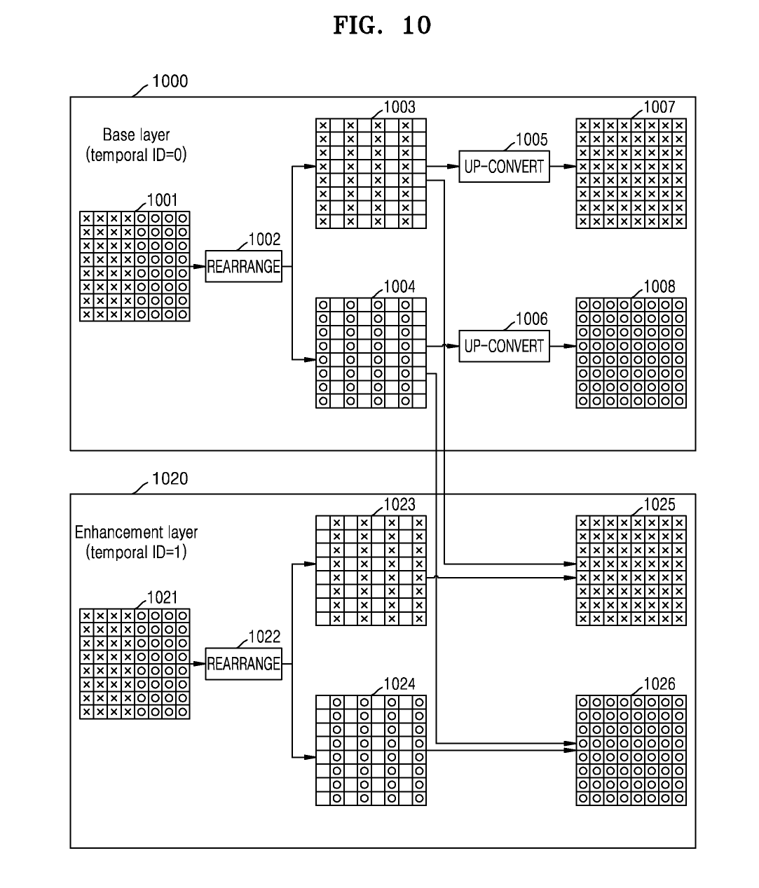

FIG. 10 is a diagram for describing a process of reproducing a 3D image data stream, according to an exemplary embodiment.

Referring to FIG. 10, it is assumed that each of a first partial image 1001 of a basic layer and a second partial image 1021 of an enhancement layer is generated by using a side-by-side method from among various FPA methods. In other words, it is assumed that the first partial image 1001 includes data of even columns of a left viewpoint image in full resolution and data of even columns of a right viewpoint image in full resolution, and the second partial image 1021 includes data of odd columns of the left viewpoint image in full resolution and data of odd columns of the right viewpoint image in full resolution. Also, it is assumed that, regarding a current image data stream generated based on the first stream generating method, image data having 0 as a temporal identifier temporal_id includes the first partial image 1001 and image data having 1 as a temporal identifier temporal_id includes the second partial image 1021.

The image decoder 95 of the apparatus 90 decodes the first partial image 1001 included in the current image data stream. The 3D image de-multiplexer 98 rearranges the decoded first partial image 1001 in operation 1002 so as to obtain an image 1003 including the data of the even columns of the first viewpoint image in full resolution and an image 1004 including the data of the even columns of the second viewpoint image in full resolution.

Also, the image decoder 95 decodes the second partial image 1021 included in the current image data stream. The 3D image de-multiplexer 98 rearranges the decoded second partial image 1021 in operation 1022 to obtain an image 1023 including the data of the odd columns of the first viewpoint image in full resolution and an image 1024 including the data of the odd columns of the second viewpoint image in full resolution.

If, in contrast to a receiver configured to process an enhancement layer image, a receiver is unable to process an enhancement layer image, the image 1003 including the data of the even columns of the first viewpoint image in full resolution and the image 1004 including the data of the even columns of the second viewpoint image in full resolution are obtained by only using the first partial image 1001, and the images 1003 and 1004 may be up-converted in operations 1005 and 1006 to obtain a first viewpoint image 1007 in full resolution and a second viewpoint image 1008 in full resolution.

If the basic layer image and the enhancement layer image are both received and decoded, a first viewpoint image 1025 in full resolution may be obtained by combining the image 1003 obtained from the first partial image 1001 and the image 1023 obtained from the second partial image 1021. Also, if the basic layer image and the enhancement layer image are both received and decoded, a second viewpoint image 1026 in full resolution may be obtained by combining the image 1004 obtained from the second partial image 1021 and the image 1024 obtained from the second partial image 1021. Since the first viewpoint image 1025 in full resolution and the second viewpoint image 1026 in full resolution have pixel values corresponding to those of an original input image, the first and second viewpoint images 1025 and 1026 have high quality compared to the first and second viewpoint images 1007 and 1008, which are generated by performing the up-conversion by only using the basic layer image.

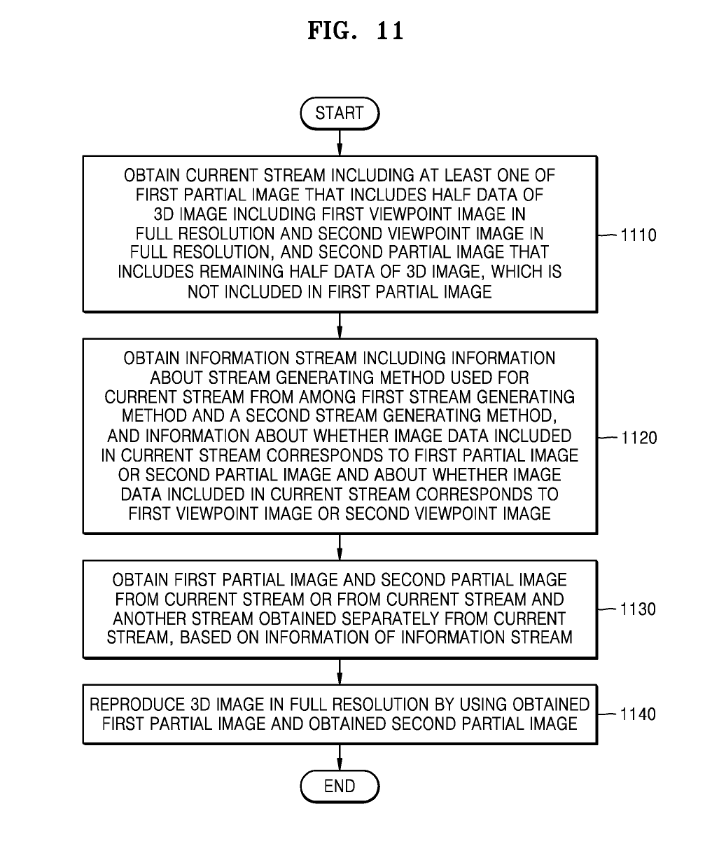

FIG. 11 is a flowchart of a method of reproducing a 3D image data stream, according to an exemplary embodiment.

Referring to FIGS. 9 and 11, in operation 1110, the image data stream obtainer 93 obtains a current stream including at least one of a first partial image that includes half data of a 3D image including a first viewpoint image in full resolution and a second viewpoint image in full resolution, and a second partial image that includes the remaining half data of the 3D image, which is not included in the first partial image.

In operation 1120, the information stream obtainer 92 obtains an information stream including information about a stream generating method used for the current stream from among a first stream generating method that inserts information about the first partial image and the second partial image into one stream, and a second stream generating method that inserts the information about the first partial image into a basic layer stream and the information about the second partial image into an enhancement layer stream, and information about whether image data included in the current stream corresponds to the first partial image or the second partial image and about whether the image data included in the current stream corresponds to a first viewpoint image or a second viewpoint image. As described above, the information stream may be transmitted through an SEI message.

In operation 1130, the image decoder 95 obtains the first partial image and the second partial image from the current stream or from the current stream and another stream obtained separately from the current stream, based on the information of the information stream. As described above, if the current stream is generated based on the first stream generating method, the image decoder 95 may obtain the first and second partial images from the current stream. If the current stream is generated based on the second stream generating method, the image decoder 95 may obtain the first and second partial images respectively from the current stream and the other stream obtained separately from the current stream.

In operation 1140, the first image decoder 96 of the image decoder 95 decodes the first partial image and the second image decoder 97 of the image decoder 95 decodes the second partial image, and the 3D image de-multiplexer 98 rearranges the first and second partial images to output the first viewpoint image in full resolution and the second viewpoint image in full resolution.

Hereinafter, a video encoding method and apparatus, and a video decoding method and apparatus according to HEVC, which perform encoding and decoding based on coding units having a tree structure, will be described with reference to FIGS. 12 through 24. The video encoding method and apparatus may be applied to the image encoder 12 of FIG. 1, and the video decoding method and apparatus may be applied to the image decoder 95 of FIG. 9.

FIG. 12 is a block diagram of a video encoding apparatus 100 configured to encode video using video prediction based on coding units having a tree structure, according to an exemplary embodiment.

The video encoding apparatus 100 configured to encode video using video prediction based on coding units having a tree structure includes a maximum coding unit splitter 110, a coding unit determiner 120, and an output unit 130. For convenience of explanation, the video encoding apparatus 100 configured to encode video using video prediction based on coding units having a tree structure may hereinafter also be referred to as ‘the video encoding apparatus 100’.

The maximum coding unit splitter 110 may split a current picture of an image based on a maximum coding unit for the current picture. If the current picture is larger than the maximum coding unit, image data of the current picture may be split into at least one maximum coding unit. The maximum coding unit according to an exemplary embodiment may be a data unit having a size of 32×32, 64×64, 128×128, 256×256, etc., wherein a shape of the data unit is a square having a width and length in squares of 2. The image data may be output to the coding unit determiner 120 according to the at least one maximum coding unit.

A coding unit according to an exemplary embodiment may be characterized by a maximum size and a depth. The depth denotes a number of times the coding unit is spatially split from the maximum coding unit, and as the depth deepens, coding units corresponding to depths may be split from the maximum coding unit to a minimum coding unit. A depth of the maximum coding unit may be determined as an uppermost depth, and the minimum coding unit may be determined as a lowermost coding unit. Since a size of a coding unit corresponding to each depth decreases as the depth of the maximum coding unit deepens, a coding unit corresponding to an upper depth may include a plurality of coding units corresponding to lower depths.

As described above, the image data of the current picture is split into the maximum coding units according to a maximum size of the coding unit, and each of the maximum coding units may include coding units that are split according to depths. Since the maximum coding unit according to an exemplary embodiment is split according to depths, the image data of a spatial domain included in the maximum coding unit may be hierarchically classified according to the depths.

A maximum depth and a maximum size of a coding unit, which limit the total number of times a height and a width of the maximum coding unit are hierarchically split, may be predetermined.

The coding unit determiner 120 encodes at least one split region obtained by splitting a region of the maximum coding unit according to depths, and determines a depth to output a finally encoded image data according to the at least one split region. In other words, the coding unit determiner 120 determines a coded depth by encoding the image data in the coding units corresponding to depths in units of the maximum coding units of the current picture, and selecting a depth having the least encoding error. The determined coded depth and the image data in each of the maximum coding units are output to the output unit 130.

The image data in each of the maximum coding units is encoded based on the coding units corresponding to depths, according to at least one depth equal to or below the maximum depth, and results of encoding the image data based on the coding units corresponding to depths are compared. A depth having the least encoding error may be selected after comparing encoding errors of the coding units corresponding to depths. At least one coded depth may be selected for each of the maximum coding units.

The size of the maximum coding unit is split as a coding unit is hierarchically split according to depths, and the number of coding units increases. Also, even if coding units included in one maximum coding unit correspond to the same depth, whether each of the coding units will be split to a lower depth is determined by measuring an encoding error of the image data of each of the coding units. Thus, since even data included in one maximum coding unit has a different encoding error corresponding to a depth, according to the location of the data, a coded depth may be differently set according to the location of the data. Accordingly, at least one coded depth may be set for one maximum coding unit, and the image data of the maximum coding unit may be divided according to coding units of the at least one coded depth.

Accordingly, the coding unit determiner 120 according to an exemplary embodiment may determine coding units having a tree structure included in a current maximum coding unit. The ‘coding units having a tree structure’ according to an exemplary embodiment include coding units corresponding to a depth determined to be the coded depth, from among all coding units corresponding to depths included in the current maximum coding unit. Coding units corresponding to a coded depth may be hierarchically determined according to depths in the same region of the maximum coding unit, and may be independently determined in different regions of the maximum coding unit. Similarly, a coded depth in a current region may be independently determined from a coded depth in another region.

A maximum depth according to an exemplary embodiment is an index related to the number of splitting times from a maximum coding unit to a minimum coding unit. A first maximum depth according to an exemplary embodiment may denote the total number of splitting times from the maximum coding unit to the minimum coding unit. A second maximum depth according to an exemplary embodiment may denote the total number of depth levels from the maximum coding unit to the minimum coding unit. For example, when a depth of the maximum coding unit is 0, a depth of a coding unit obtained by splitting the maximum coding unit once may be set to 1, and a depth of a coding unit obtained by splitting the maximum coding unit twice may be set to 2. If a coding unit obtained by splitting the maximum coding unit four times is the minimum coding unit, then depth levels of depths 0, 1, 2, 3 and 4 exist. Thus, the first maximum depth may be set to 4, and the second maximum depth may be set to 5.

Prediction-encoding and transformation may be performed on the maximum coding unit. Similarly, prediction-encoding and transformation are performed in units of maximum coding units, based on coding units corresponding to depths and according to depths equal to or less than the maximum depth.

Since the number of coding units corresponding to depths increases whenever the maximum coding unit is split according to depths, encoding operations, including prediction-encoding and transformation, should be performed on all of the coding units corresponding to depths generated as a depth deepens. For convenience of explanation, prediction-encoding and transformation will now be described based on a coding unit of a current depth, included in at least one maximum coding unit.

The video encoding apparatus 100 may variously select a size or shape of a data unit for encoding image data. In order to encode the image data, operations, such as prediction-encoding, transformation, and entropy encoding, are performed. At this time, the same data unit may be used for all of the operations or different data units may be used for each operation.

For example, the video encoding apparatus 100 may select not only a coding unit for encoding the image data, but also a data unit different from the coding unit so as to perform prediction-encoding on image data in the coding unit.

In order to prediction-encode the maximum coding unit, prediction-encoding may be performed based on a coding unit corresponding to a coded depth, e.g., based on a coding unit that is no longer split to coding units corresponding to a lower depth. Hereinafter, the coding unit that is no longer split and becomes a basis unit for prediction-encoding may also be referred to as a ‘prediction unit’. Partitions obtained by splitting the prediction unit may include a data unit obtained by splitting at least one of a height and a width of the prediction unit. The partitions may be data units obtained by splitting a prediction unit of a coding unit, and the prediction unit may be a partition having the same size as that of the coding unit.

For example, when a coding unit of 2N×2N (where N is a positive integer) is no longer split, the coding unit becomes a prediction unit of 2N×2N, and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, an inter mode, and a skip mode. For example, the intra mode or the inter mode may be performed on a partition of 2N×2N, 2N×N, N×2N, or N×N. Also, the skip mode may be performed only on a partition of 2N×2N. Encoding may be independently performed on one prediction unit in each coding unit, and a prediction mode having a least encoding error may be selected.

Also, the video encoding apparatus 100 may perform transformation on the image data in a coding unit based not only on the coding unit for encoding the image data, but also based on a data unit that is different from the coding unit. In order to perform transformation on the coding unit, transformation may be performed based on a data unit having a size smaller than or equal to a size of the coding unit. For example, transformation units may include a data unit for the intra mode and a data unit for the inter mode.

Similarly to coding units having a tree structure according to an exemplary embodiment, a transformation unit in a coding unit may be recursively split into smaller sized transformation units. Thus, residual data in the coding unit may be divided according to transformation units having a tree structure according to transformation depths.

A transformation unit according to an exemplary embodiment may also be assigned a transformation depth denoting a number of times the height and width of a coding unit are split to obtain the transformation unit. For example, a transformation depth may be 0 when a size of a transformation unit for a 2N×2N current coding unit is 2N×2N, a transformation depth may be 1 when a size of a transformation unit for the 2N×2N current coding unit is N×N, and a transformation depth may be 2 when a size of a transformation unit for the 2N×2N current coding unit is N/2×N/2. That is, transformation units having a tree structure may also be set according to transformation depths.

Encoding information for each coded depth requires not only information about the coded depth, but also about information related to prediction-encoding and transformation. Accordingly, the coding unit determiner 120 may not only determine a coded depth having a least encoding error, but also determine a partition type in a prediction unit, a prediction mode for each prediction unit, and a size of a transformation unit for transformation.

Coding units having a tree structure included in a maximum coding unit and a method of determining a prediction unit or partition and a transformation unit, according to exemplary embodiments, will be described in detail later.

The coding unit determiner 120 may measure encoding errors of coding units corresponding to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode of each of depths, in a bitstream.

The encoded image data may be a result of encoding residual data of an image.

The information about the encoding mode of each of depths may include information about the coded depth, about the partition type in the prediction unit, the prediction mode, and the size of the transformation unit.

The information about the coded depth may be defined using split information according to depths, which indicates whether encoding is to be performed on coding units of a lower depth instead of a current depth. If a current depth of a current coding unit is the coded depth, then the current coding unit is encoded using coding units corresponding to the current depth, and split information about the current depth may thus be defined such that the current coding unit of the current depth may not be split any further into coding units of a lower depth. Reversely, if the current depth of the current coding unit is not the coded depth, then coding units of a lower depth should be encoded and the split information about the current depth may thus be defined such that the current coding unit of the current depth may be split into coding units of a lower depth.

If the current depth is not the coded depth, encoding is performed on the coding units of the lower depth. Since at least one coding unit of the lower depth exists in one coding unit of the current depth, encoding is repeatedly performed on each coding unit of the lower depth, and coding units having the same depth may thus be recursively encoded.

Since coding units having a tree structure should be determined in one maximum coding unit and information about at least one encoding mode is determined for each coding unit of a coded depth, information about at least one encoding mode may be determined for one maximum coding unit. Also, image data of the maximum coding unit may have a different coded depth according to the location thereof since the image data is hierarchically split according to depths. Thus, information about a coded depth and an encoding mode may be set for the image data.

Accordingly, the output unit 130 according to an exemplary embodiment may assign encoding information about a corresponding coded depth and an encoding mode to at least one of coding units, prediction units, and a minimum unit included in the maximum coding unit.

The minimum unit according to an exemplary embodiment is a rectangular data unit obtained by splitting a minimum coding unit of a lowermost depth by 4. Alternatively, the minimum unit may be a maximum rectangular data unit that may be included in all of the coding units, prediction units, partition units, and transformation units included in the maximum coding unit.

For example, encoding information output via the output unit 130 may be classified into encoding information of each of coding units corresponding to depths, and encoding information of each of prediction units. The encoding information of each of coding units corresponding to depths may include prediction mode information and partition size information. The encoding information of each of prediction units may include information about an estimated direction of an inter mode, about a reference image index of the inter mode, about a motion vector, about a chroma component of the intra mode, and about an interpolation method of an intra mode.

Information about a maximum size of coding units defined in units of pictures, slices, or GOPs, and information about a maximum depth may be inserted into a header of a bitstream, a sequence parameter set (SPS) or a Picture parameter set (PPS).

Also, information about a maximum size and a minimum size of a transformation unit available in a current video may be transmitted via a header of a bitstream, an SPS, or a PPS. The output unit 130 may encode and output information about scalability of coding units.

In the video encoding apparatus 100 according to an exemplary embodiment, coding units corresponding to depths may be coding units obtained by dividing a height or width of a coding unit of an upper depth by two. In other words, when the size of a coding unit of a current depth is 2N×2N, the size of a coding unit of a lower depth is N×N. Also, the 2N×2N coding unit may include four N×N coding units of the lower depth.

Accordingly, the video encoding apparatus 100 may form coding units having a tree structure by determining coding units having an optimum shape and size for each maximum coding unit, based on the size of each maximum coding unit and a maximum depth determined considering characteristics of a current picture. Also, since each maximum coding unit may be encoded according to any one of various prediction modes and transformation methods, an optimum encoding mode may be determined considering characteristics of coding units of various image sizes.

Thus, if an image having very high resolution or a very large amount of data is encoded in units of related art macroblocks, a number of macroblocks per picture excessively increases. Thus, an amount of compressed information generated for each macroblock increases, and therefore, it is difficult to transmit the compressed information and data compression efficiency decreases. However, the video encoding apparatus 100 is capable of controlling a coding unit based on characteristics of an image while increasing a maximum size of the coding unit in consideration of a size of the image, thereby increasing image compression efficiency.

FIG. 13 is a block diagram of a video decoding apparatus 200 configured to decode video using video prediction based on coding units having a tree structure, according to an exemplary embodiment.

The video decoding apparatus 200 configured to decode video using video prediction based on coding units having a tree structure includes a receiver 210, an image data and encoding information extractor 220, and an image data decoder 230. For convenience of explanation, the video decoding apparatus 200 configured to decode video using video prediction based on coding units having a tree structure may also be referred to as the ‘video decoding apparatus 200’.

Definitions of various terms, such as a coding unit, a depth, a prediction unit, a transformation unit, and information about various encoding modes, which are used below to explain decoding operations of the video decoding apparatus 200, may be identical to those of the video encoding apparatus 100 described above with reference to FIG. 12.

The receiver 210 receives and parses a bitstream of an encoded video. The image data and encoding information extractor 220 extracts encoded image data for each of coding units having a tree structure in units of maximum coding units, from the parsed bitstream, and then outputs the extracted image data to the image data decoder 230. The image data and encoding information extractor 220 may extract information about a maximum size of coding units of a current picture, from a header regarding the current picture, an SPS, or a PPS.

Also, the image data and encoding information extractor 220 extracts information about a coded depth and an encoding mode for the coding units having the tree structure in units of the maximum coding unit, from the parsed bitstream. The extracted information about the coded depth and the encoding mode is output to the image data decoder 230. In other words, the image data in the bitstream may be split into the maximum coding units so that the image data decoder 230 may decode the image data in units of the maximum coding units.

The information about the coded depth and the encoding mode for each of the maximum coding units may be set for at least one coded depth. The information about the encoding mode for each coded depth may include information about a partition type of a corresponding coding unit corresponding to the coded depth, about a prediction mode, and a size of a transformation unit. Also, splitting information according to depths may be extracted as the information about the coded depth.

The information about the coded depth and the encoding mode for each of the maximum coding units extracted by the image data and encoding information extractor 220 is information about a coded depth and an encoding mode determined to generate a minimum encoding error when an encoding side, e.g., the video encoding apparatus 100, repeatedly encodes each of coding units corresponding to depths in units of maximum coding units. Accordingly, the video decoding apparatus 200 may restore an image by decoding the image data according to the coded depth and the encoding mode that generates the minimum encoding error.

Since encoding information about the coded depth and the encoding mode may be assigned to data units from among corresponding coding units, prediction units, and a minimum unit, the image data and encoding information extractor 220 may extract the information about the coded depth and the encoding mode in units of the data units. If the information about the coded depth and the encoding mode for each of the maximum coding units is recorded in units of the data units, data units including information about the same coded depth and encoding mode may be inferred to be data units included in the same maximum coding unit.

The image data decoder 230 restores the current picture by decoding the image data in each of the maximum coding units, based on the information about the coded depth and the encoding mode for each of the maximum coding units. In other words, the image data decoder 230 may decode the encoded image data based on a parsed partition type, prediction mode, and transformation unit for each of the coding units having the tree structure included in each of the maximum coding units. A decoding process may include a prediction process including intra prediction and motion compensation, and an inverse transformation process.

The image data decoder 230 may perform intra prediction or motion compensation on each of the coding units according to partitions and a prediction mode thereof, based on the information about the partition type and the prediction mode of prediction units of each of coding units according to coded depths.

Also, in order to perform inverse transformation on each of the maximum coding units, the image data decoder 230 may parse information about transformation units having a tree structure of each of the coding units and perform inverse transformation based on the transformation units of each of the coding units. Through inverse transformation, pixel values of a spatial domain of each of the coding units may be restored.

The image data decoder 230 may determine a coded depth of a current maximum coding unit, based on split information according to depths. If the split information indicates that image data is no longer split in the current depth, the current depth is a coded depth. Thus, the image data decoder 230 may decode image data of a current maximum coding unit by using the information about the partition type of the prediction unit, the prediction mode, and the size of the transformation unit of a coding unit corresponding to a current depth.

In other words, data units containing encoding information including the same split information may be gathered by observing encoding information assigned to a data unit from among the coding unit, the prediction unit, and the minimum unit, and the gathered data units may be considered as one data unit to be decoded according to the same encoding mode by the image data decoder 230.

The video decoding apparatus 200 may obtain information about a coding unit that generates a least encoding error by recursively encoding each of the maximum coding units, and may use the information to decode the current picture. In other words, the encoded image data in the coding units having the tree structure determined to be optimum coding units in units of the maximum coding units may be decoded.

Accordingly, even if image data has high resolution and a very large amount of data, the image data may be efficiently decoded to be restored by using a size of a coding unit and an encoding mode, which are adaptively determined according to characteristics of the image data, based on information about an optimum encoding mode received from an encoding side.

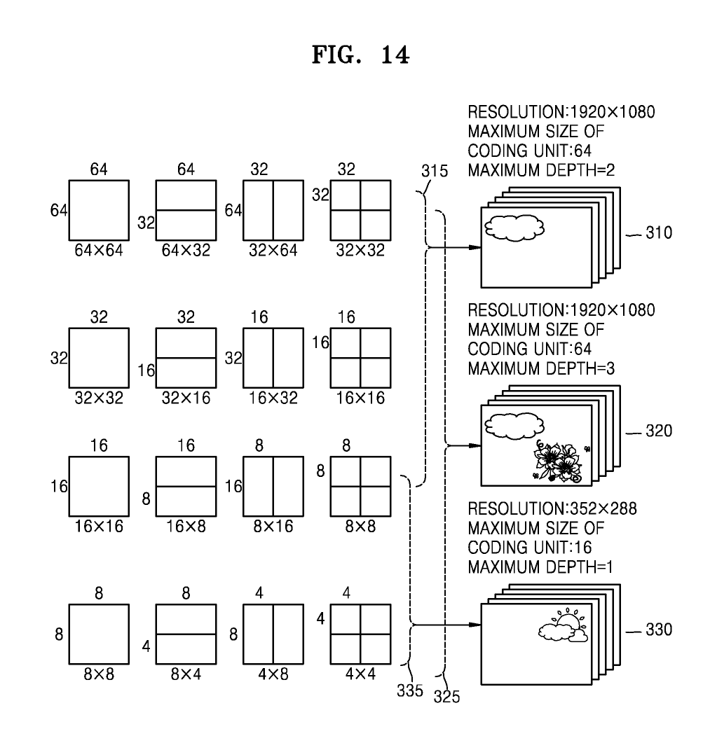

FIG. 14 illustrates a concept of coding units according to an exemplary embodiment.

A size of a coding unit may be expressed in width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 14 denotes a total number of splits from a maximum coding unit to a minimum decoding unit.

If a resolution is high or an amount of data is large, a maximum size of a coding unit may be relatively large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the video data 310 may include a maximum coding unit having a long axis size of 64, and coding units having long axis sizes of 32 and 16 since depths are deepened to two layers by splitting the maximum coding unit twice. Since the maximum depth of the video data 330 is 1, coding units 335 of the video data 330 may include a maximum coding unit having a long axis size of 16, and coding units having a long axis size of 8 since depths are deepened to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are deepened to 3 layers by splitting the maximum coding unit three times. As a depth deepens, detailed information may be precisely expressed.

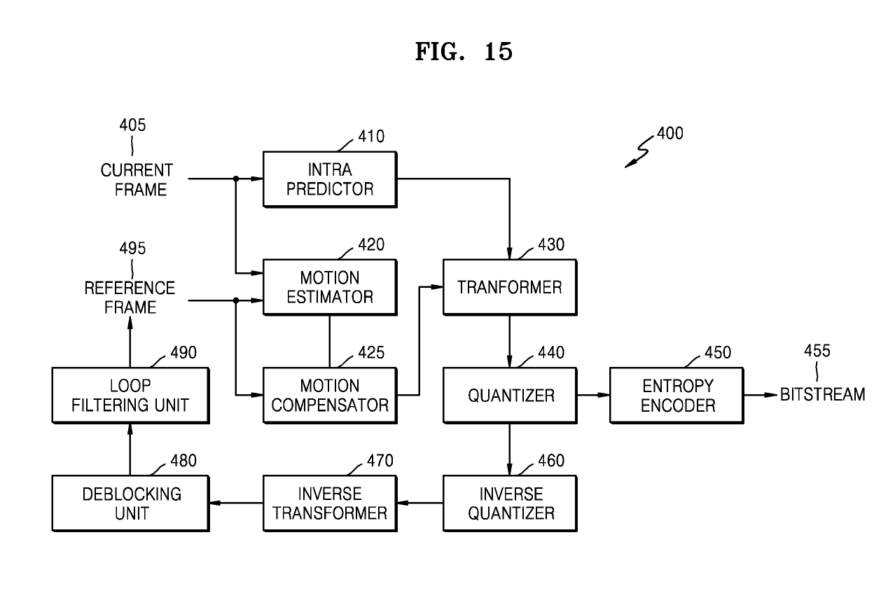

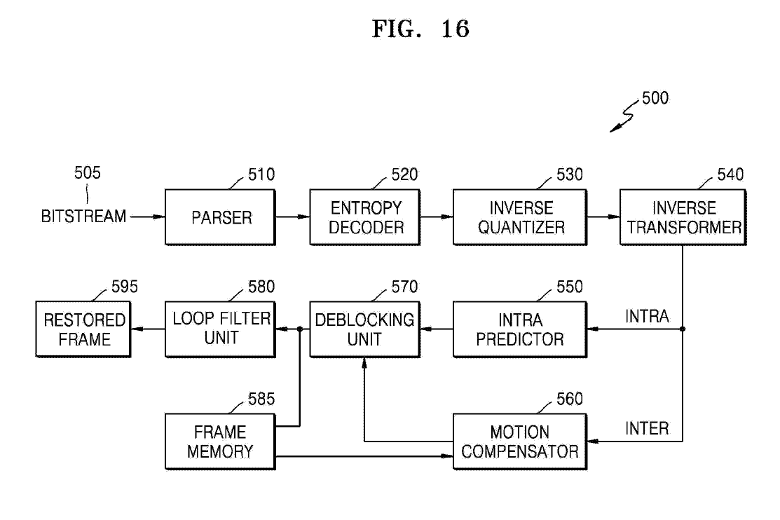

FIG. 15 is a block diagram of an image encoder 400 configured to encode images based on coding units, according to an exemplary embodiment.

The image encoder 400 performs operations of the coding unit determiner 120 of the video encoding apparatus 100 to encode image data. Specifically, an intra predictor 410 performs intra prediction on coding units in an intra mode from among a current frame 405, and a motion estimator 420 and a motion compensator 425 performs inter estimation and motion compensation on coding units in an inter mode from among the current frame 405 by using the current frame 405 and a reference frame 495.

Data output from the intra predictor 410, the motion estimator 420, and the motion compensator 425 is output as a quantized transformation coefficient through a transformer 430 and a quantizer 440. The quantized transformation coefficient is restored as data in a spatial domain through an inverse quantizer 460 and an inverse transformer 470. The restored data in the spatial domain is output as the reference frame 495 after being post-processed through a deblocking unit 480 (e.g., deblocker) and a loop filtering unit 490 (e.g., loop filter). The quantized transformation coefficient may be output in a bitstream 455 through an entropy encoder 450.

In order to implement the image encoder 400 into the video encoding apparatus 100, all elements of the image encoder 400, e.g., the intra predictor 410, the motion estimator 420, the motion compensator 425, the transformer 430, the quantizer 440, the entropy encoder 450, the inverse quantizer 460, the inverse transformer 470, the deblocking unit 480, and the loop filtering unit 490 perform operations based on each coding unit from among coding units having a tree structure while considering the maximum depth of each maximum coding unit.

Particularly, the intra predictor 410, the motion estimator 420, and the motion compensator 425 determine partitions and a prediction mode of each coding unit from among the coding units having the tree structure while considering the maximum size and the maximum depth of a current maximum coding unit. The transformer 430 determines the size of the transformation unit in each coding unit from among the coding units having the tree structure.

FIG. 16 is a block diagram of an image decoder 500 configured to decode images based on coding units, according to an exemplary embodiment.

A parser 510 parses a bitstream 505 to obtain encoded image data to be decoded and encoding information to be used to decode the encoded image data. The encoded image data is output as inversely quantized data through an entropy decoder 520 and an inverse quantizer 530, and the inverse quantized data is restored to image data in a spatial domain through an inverse transformer 540.

With respect to the image data in the spatial domain, an intra predictor 550 performs intra prediction on coding units in an intra mode, and a motion compensator 560 performs motion compensation on coding units in an inter mode by using a reference frame stored in a frame memory 585.

The image data in the spatial domain, which passed through the intra predictor 550 and the motion compensator 560, may be output as a restored frame 595 after being post-processed through a deblocking unit 570 (e.g., deblocker) and a loop filtering unit 580 (e.g., loop filter). Also, the image data that is post-processed through the deblocking unit 570 and the loop filtering unit 580 may be output as the reference frame stored in the frame memory 585.

In order to decode the image data by using the image data decoder 230 of the video decoding apparatus 200, the image decoder 500 may perform operations that are performed after an operation of the parser 510.

In order to implement the image decoder 500 into the video decoding apparatus 200, all elements of the image decoder 500, e.g., the parser 510, the entropy decoder 520, the inverse quantizer 530, the inverse transformer 540, the intra predictor 550, the motion compensator 560, the deblocking unit 570, and the loop filtering unit 580 perform operations based on coding units having a tree structure, in units of maximum coding units.

Particularly, the intra prediction 550 and the motion compensator 560 determine partitions and a prediction mode for each of the coding units having the tree structure, and the inverse transformer 540 determines a size of a transformation unit for each of the coding units.

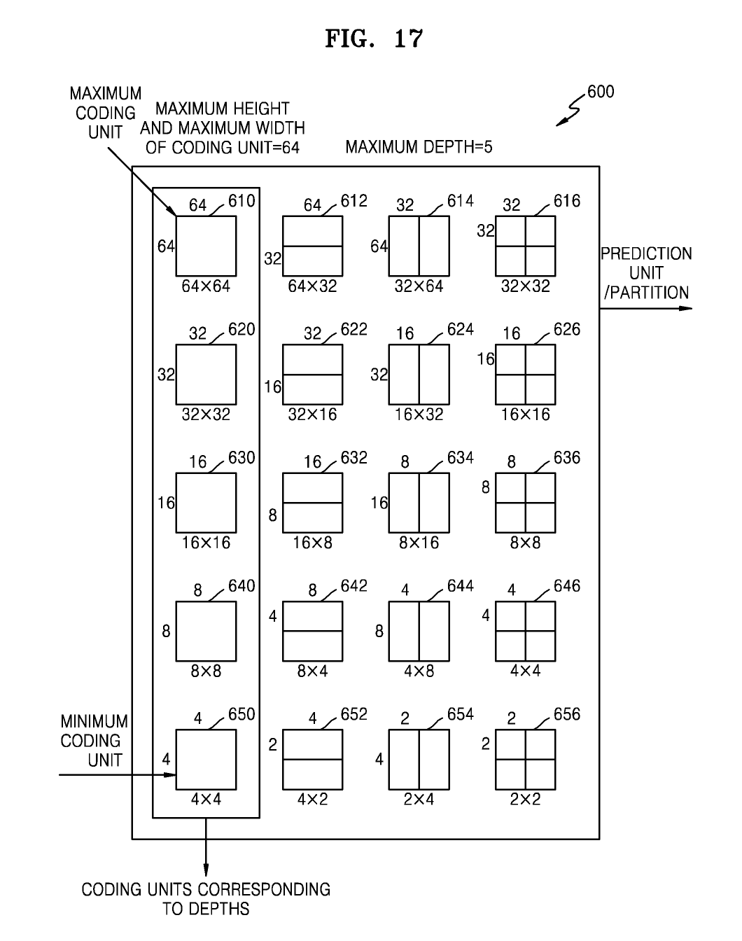

FIG. 17 is a diagram illustrating coding units corresponding to depths, and partitions, according to an exemplary embodiment.

The video encoding apparatus 100 and the video decoding apparatus 200 according to an exemplary embodiment use hierarchical coding units to consider characteristics of an image. A maximum height, a maximum width, and a maximum depth of a coding unit may be adaptively determined according to the characteristics of the image, or may be differently set by a user. Sizes of coding units corresponding to depths may be determined according to the predetermined maximum size of the coding unit.

In a hierarchical structure 600 of coding units according to an exemplary embodiment, the maximum height and the maximum width of the coding units are each 64, and the maximum depth is 4. The maximum depth denotes a total number of splitting times from a maximum coding unit to a minimum coding unit. Since a depth deepens along a vertical axis of the hierarchical structure 600, a height and width of each of coding units corresponding to depths are each split. Also, a prediction unit and partitions, which are bases for prediction-encoding each of the coding units corresponding to depths, are shown along a horizontal axis of the hierarchical structure 600.

Specifically, in the hierarchical structure 600, a coding unit 610 is a maximum coding unit, and has a depth of 0 and a size of 64×64 (height×width). As the depth deepens along the vertical axis, a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

A prediction unit and partitions of each coding unit are arranged along the horizontal axis according to each depth. If the coding unit 610 having the size of 64×64 and the depth of 0 is a prediction unit, the prediction unit may be split into partitions included in the coding unit 610, e.g., a partition 610 having a size of 64×64, partitions 612 having a size of 64×32, partitions 614 having a size of 32×64, or partitions 616 having a size of 32×32.

Similarly, a prediction unit of the coding unit 620 having the size of 32×32 and the depth of 1 may be split into partitions included in the coding unit 620, e.g., a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, e.g., a partition 630 having a size of 16×16, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, e.g., a partition 640 having a size of 8×8, partitions 642 having a size of 8×4, partitions 644 having a size of 4×8, and partitions 646 having a size of 4×4.

The coding unit 650 having the size of 4×4 and the depth of 4 is the minimum coding unit having a lowermost depth. A prediction unit of the coding unit 650 is set to only a partition 650 having a size of 4×4.

In order to determine a coded depth of the maximum coding unit 610, the coding unit determiner 120 of the video encoding apparatus 100 encodes all coding units corresponding to each depth, included in the maximum coding unit 610.

As the depth deepens, a number of coding units, which correspond to each depth and include data having the same range and the same size, increases. For example, four coding units corresponding to a depth of 2 are required to cover data included in one coding unit corresponding to a depth of 1. Accordingly, in order to compare results of encoding the same data according to depths, the coding unit corresponding to the depth of 1 and the four coding units corresponding to the depth of 2 are each encoded.

In order to perform encoding in units of depths, a least encoding error of each of the depths may be selected as a representative encoding error by encoding prediction units in each of the coding units corresponding to the depths, along the horizontal axis of the hierarchical structure 600. Alternatively, a least encoding error may be searched for by performing encoding in units of depths and comparing least encoding errors according to the depths, as the depth deepens along the vertical axis of the hierarchical structure 600. A depth and a partition having the least encoding error in the maximum coding unit 610 may be selected as a coded depth and a partition type of the maximum coding unit 610.

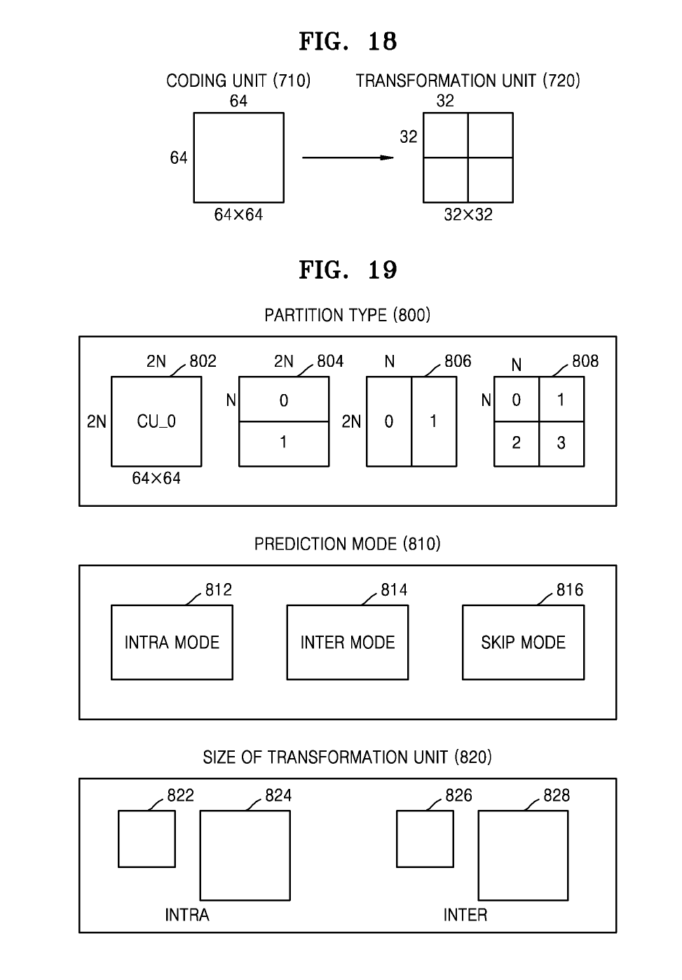

FIG. 18 is a diagram illustrating a relationship between a coding unit 710 and transformation units 720, according to an exemplary embodiment.

The video encoding apparatus 100 (or the video decoding apparatus 200) according to an exemplary embodiment encodes (or decodes) an image in units of maximum coding units, based on coding units having sizes smaller than or equal to the maximum coding units. During the encoding, a size of each transformation unit used to perform transformation may be selected based on a data unit that is not larger than a corresponding coding unit.

For example, in the video encoding apparatus 100 (or the video decoding apparatus 200), if a size of the coding unit 710 is 64×64, transformation may be performed using the transformation units 720 having a size of 32×32.

Also, data of the coding unit 710 having the size of 64×64 may be encoded by performing transformation on each of transformation units having a size of 32×32, 16×16, 8×8, and 4×4, which are smaller than 64×64, and then a transformation unit having a least coding error may be selected.

FIG. 19 is a diagram illustrating encoding information corresponding to depths, according to an exemplary embodiment.

The output unit 130 of the video encoding apparatus 100 may encode and transmit information 800 about a partition type, information 810 about a prediction mode, and information 820 about a transformation unit size for each coding unit corresponding to a coded depth, as information about an encoding mode.

The information 800 indicates information about a shape of a partition obtained by splitting a prediction unit of a current coding unit, as a data unit for prediction-encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. In this case, the information 800 is set to indicate one of the partition 804 having a size of 2N×N, the partition 806 having a size of N×2N, and the partition 808 having a size of N×N

The information 810 indicates a prediction mode of each partition. For example, the information 810 may indicate a mode of prediction-encoding the partition indicated by the information 800, e.g., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 may extract and use the information 800, 810, and 820 for decoding coding units corresponding to depths.

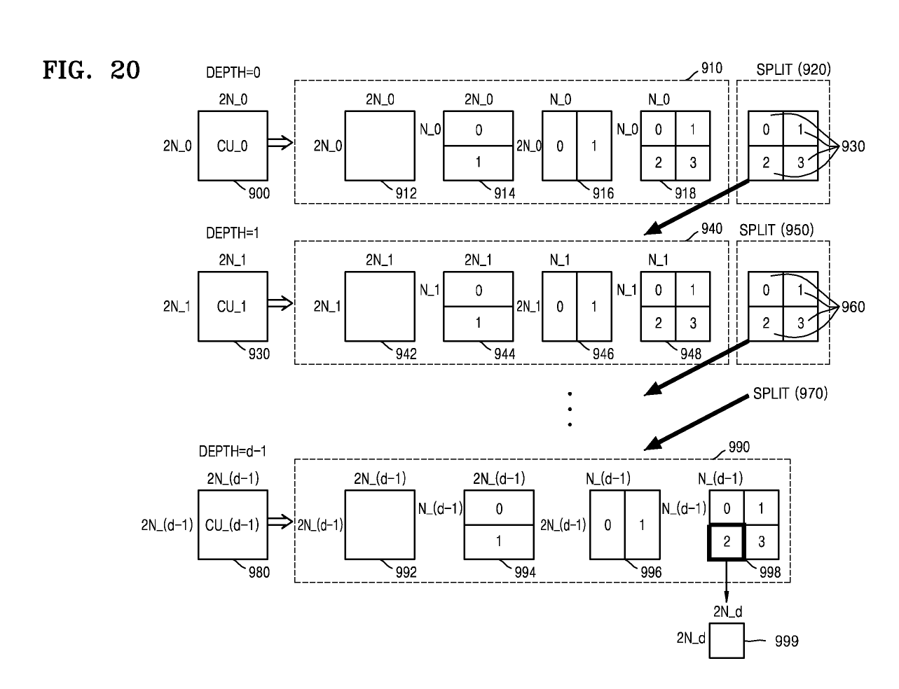

FIG. 20 is a diagram illustrating coding units corresponding to depths, according to an exemplary embodiment.

Split information may be used to indicate a depth change. The spilt information indicates whether a coding unit of a current depth is split into coding units of a lower depth.

A prediction unit 910 for prediction-encoding a coding unit 900 having a depth of 0 and a size 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. Although FIG. 20 illustrates only the partition types 912 through 918 which are obtained by symmetrically splitting the prediction unit 910, a partition type is not limited thereto, and the partitions of the prediction unit 910 may include asymmetrical partitions, partitions having an arbitrary shape, and partitions having a geometrical shape.

Prediction-encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. Prediction-encoding may be performed on the partitions having the sizes of 2N_{—}0×2N_{—}0, N_{—}0×2N_{—}0, 2N_{—}0×N_{—}0, and N_{—}0×N_{—}0, according to an intra mode and an inter mode. Prediction-encoding is performed only on the partition having the size of 2N_{—}0×2N_{—}0, according to a skip mode.

If an encoding error is smallest in one of the partition types 912 through 916, the prediction unit 910 may not be split into a lower depth.

If an encoding error is the smallest in the partition type 918, a depth is changed from 0 to 1 to split the partition type 918 in operation 920, and encoding is repeatedly performed on coding units 930 having partitions of a depth of 2 and a size of N_{—}0×N_{—}0 to search for a minimum encoding error.

A prediction unit 940 for prediction-encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—1}, a partition type 946 having a size of N_{—}1×2N_{—}1, and a partition type 948 having a size of N_{—}1×N_{—1}.

If an encoding error is the smallest in the partition type 948 having a size of N_{—}1×N_{—1}, a depth is changed from 1 to 2 to split the partition type 948 in operation 950, and encoding is repeatedly performed on coding units 960 having a depth of 2 and a size of N_{—}2×N_{—}2 so as to search for a minimum encoding error.

When a maximum depth is d, coding units corresponding to depths may be set up to when a depth becomes d−1, and split information may be set up to when a depth is d−2. In other words, when encoding is performed up to when the depth is d−1 after a coding unit corresponding to a depth of d−2 is split in operation 970, a prediction unit 990 for prediction-encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction-encoding may be repeatedly performed on one partition having a size of 2N_(d−1)×2N_(d−1), two partitions having a size of 2N_(d−1)×N_(d−1), two partitions having a size of N_(d−1)×2N_(d−1), and four partitions having a size of N_(d−1)×N_(d−1) from among the partition types 992 through 998 so as to search for a partition type having a minimum encoding error.

Even when the partition type 998 has the minimum encoding error, since a maximum depth is d, a coding unit CU_(d−1) having a depth of d−1 is no longer split to a lower depth, and a coded depth for a current maximum coding unit 900 is determined to be d−1 and a partition type of the coding unit 900 may be determined to be N_(d−1)×N_(d−1). Also, since the maximum depth is d, split information is not set for a coding unit 952 having a depth of (d−1).

A data unit 999 may be a ‘minimum unit’ for the current maximum coding unit 900. A minimum unit according to an exemplary embodiment may be a rectangular data unit obtained by splitting a minimum unit having a lowest coded depth by 4. By performing encoding repeatedly as described above, the video encoding apparatus 100 may determine a coded depth by comparing encoding errors according to depths of the coding unit 900 and selecting a depth having the least encoding error, and set a partition type and a prediction mode for the coding unit 900 as an encoding mode of the coded depth.

As such, minimum encoding errors according to depths, e.g., the depths of 0, 1, . . . , d−1, and d, are compared with one another, and a depth having the least encoding error may be determined as a coded depth. The coded depth, the partition type of the prediction unit, and the prediction mode may be encoded and transmitted as information about an encoding mode. Also, since a coding unit is split from the depth of 0 to the coded depth, only split information of the coded depth is set to 0, and split information of the other depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a depth corresponding to split information ‘0’, as a coded depth, based on split information according to depths, and may use information about an encoding mode of the coded depth during a decoding process.

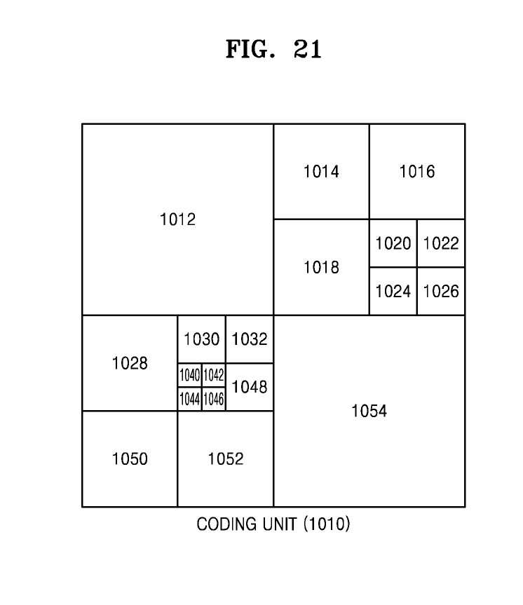

FIGS. 21, 22, and 23 are diagrams illustrating a relationship between coding units 1010, prediction units 1060, and transformation units 1070, according to an exemplary embodiment.

The coding units 1010 are coding units corresponding to coded depths for a maximum coding unit, determined by the video encoding apparatus 100. The prediction units 1060 are partitions of prediction units of the respective coding units 1010, and the transformation units 1070 are transformation units of the respective coding units 1010.

Among the coding units 1010, if a depth of a maximum coding unit is 0, then coding units 1012 and 1054 have a depth of 1, coding units 1014, 1016, 1018, 1028, 1050, and 1052 have a depth of 2, coding units 1020, 1022, 1024, 1026, 1030, 1032, and 1048 have a depth of 3, and coding units 1040, 1042, 1044, and 1046 have a depth of 4.

Among the prediction units 1060, some partitions 1014, 1016, 1022, 1032, 1048, 1050, 1052, and 1054 are split into partitions split from coding units. In other words, the partitions 1014, 1022, 1050, and 1054 are 2N×N partition types, partitions 1016, 1048, and 1052 are N×2N partition types, and the partition 1032 is an N×N partition type. Prediction units and partitions of the coding units 1010 are smaller than or equal to coding units corresponding thereto.

Among the transformation units 1070, transformation or inverse transformation is performed on image data corresponding to coding unit 1052, based on a data unit that is smaller than the coding unit 1052. Also, transformation units 1014, 1016, 1022, 1032, 1048, 1050, 1052, and 1054 are data units different from corresponding prediction units and partitions among the prediction units 1060, in terms of sizes and shapes. In other words, the video encoding apparatus 100 and the video decoding apparatus 200 according to an exemplary embodiment may individually perform intra prediction, motion estimation, motion compensation, transformation, and inverse transformation on the same coding unit, based on different data units.

Accordingly, an optimum coding unit may be determined by recursively encoding coding units having a hierarchical structure, in units of regions of each maximum coding unit, thereby obtaining coding units having a recursive tree structure. Encoding information may include split information about a coding unit, information about a partition type, information about a prediction mode, and information about a size of a transformation unit. Table 1 shows an example of encoding information that may be set by the video encoding apparatus 100 and the video decoding apparatus 200.

TABLE 1

| | | | | | Split |
|---|---|---|---|---|---|
| Split Information 0 | | | | | Information |
| (Encoding on Coding Unit having Size of 2N × 2N and Current Depth of d) | | | | | 1 |
| Prediction | Partition Type | | Size of Transformation Unit | | Repeatedly |
| Mode | | | | | Encode |
| Intra | Symmetrical | Asymmetrical | Split | Split | Coding |
| Inter | Partition | Partition | Information 0 | Information 1 | Units |
| Skip | Type | Type | of | of | having |
| (Only | | | Transformation | Transformation | Lower |
| 2N × 2N) | | | Unit | Unit | Depth of |
| | 2N × 2N | 2N × nU | 2N × 2N | N × N | d + 1 |
| | 2N × N | 2N × nD | | (Symmetrical | |
| | N × 2N | nL × 2N | | Type) | |
| | N × N | nR × 2N | | N/2 × N/2 | |
| | | | | (Asymmetrical | |
| | | | | Type) | |

The output unit 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Split information indicates whether a current coding unit is split into coding units of a lower depth. If split information of a current depth d is 0, a depth, in which the current coding unit is no longer split into coding units of a lower depth, is a coded depth, and thus information about a partition type, a prediction mode, and a size of a transformation unit may be defined for the coded depth. If the current coding unit is further split according to the split information, encoding is independently performed on four split coding units of a lower depth.

The prediction mode may be one of an intra mode, an inter mode, and a skip mode. The intra mode and the inter mode may be defined for all partition types, and the skip mode is defined only for a 2N×2N partition type.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1 ratios, and the asymmetrical partition types having the sizes of nL×2N and nR×2N may be respectively obtained by splitting the width of the prediction unit in 1:3 and 3:1 ratios.

The size of the transformation unit may be set to be two types in the intra mode and two types in the inter mode. In other words, if split information of the transformation unit is 0, the size of the transformation unit may be 2N×2N to be equal to the size of the current coding unit. If the split information of the transformation unit is 1, transformation units may be obtained by splitting the current coding unit. Also, a size of a transformation unit may be N×N when a partition type of the current coding unit having the size of 2N×2N is a symmetrical partition type, and may be N/2×N/2 when the partition type of the current coding unit is an asymmetrical partition type.

The encoding information about coding units having a tree structure may be assigned to at least one of a coding unit corresponding to a coded depth, a prediction unit, and a minimum unit. The coding unit corresponding to the coded depth may include at least one prediction unit and at least one minimum unit that contain the same encoding information.

Accordingly, whether adjacent data units are included in coding units corresponding to the same coded depth may be determined by comparing encoding information of the adjacent data units. Also, a coding unit corresponding to a coded depth may be determined using encoding information of a data unit. Thus, a distribution of coded depths in a maximum coding unit may be determined.

Accordingly, if the current coding unit is predicted based on encoding information of adjacent data units, encoding information of data units in coding units corresponding to depths adjacent to the current coding unit may be directly referred to and used.

Alternatively, if the current coding unit is predicted based on adjacent coding units, then adjacent coding units may be referred to by searching data units adjacent to the current coding unit from among coding units corresponding to depths, based on encoding information of adjacent coding units corresponding to depths.

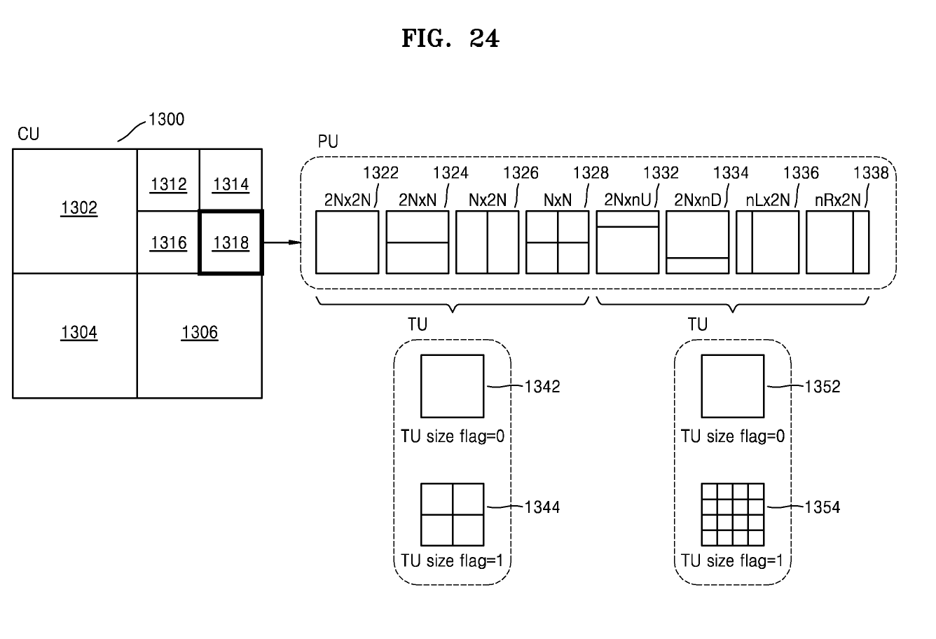

FIG. 24 is a diagram illustrating a relationship between a coding unit, a prediction unit, and a transformation unit, according to encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information thereof may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Transformation unit split information, e.g., a Tu size flag, is a type of transformation index. The size of a transformation unit corresponding to the transformation index may vary according to a prediction unit type or a partition type of a coding unit.

For example, if the partition type is set to be a symmetrical partition type, e.g., the partition type 1322, 1324, 1326, or 1328, then a transformation unit 1342 having a size of 2N×2N is set when the TU size flag is ‘0’, and a transformation unit 1344 having a size of N×N is set when the TU size flag is ‘1’.

If the partition type is set to be an asymmetrical partition type, e.g., the partition type 1332, 1334, 1336, or 1338, then a transformation unit 1352 having a size of 2N×2N is set when a TU size flag is 0, and a transformation unit 1354 having a size of N/2×N/2 is set when a TU size flag is 1.

Those of ordinary skill in the art would understand the block diagrams disclosed in the description of the exemplary embodiments as conceptual diagrams of circuits for realizing the principles of the exemplary embodiments. Similarly, it would be apparent to those of ordinary skill in the art that arbitrary flow charts, flow diagrams, state transition diagrams, pseudo code, and the like denote various processes that may be substantially stored in a computer readable recording medium and that may be performed by a computer or a processor, regardless of whether the computer or the processor are explicitly illustrated or not. Thus, the exemplary embodiments described above may be embodied as a computer program. The computer program may be stored in a computer readable recording medium, and executed using a general digital computer. Examples of the computer readable medium are a magnetic recording medium (a ROM, a floppy disc, a hard disc, etc.), and an optical recording medium (a CD-ROM, a DVD, etc.).

The functions of various elements illustrated in the drawings may be related to appropriate software, and be provided via not only hardware capable of executing the software but also exclusive hardware. These functions may also be provided via a single exclusive processor, a single shared processor, or a plurality of individual processors, some of which may be shared. Also, the explicit use of the term ‘processor’ or ‘controller’ is not limited to exclusively using hardware capable of executing software, and may implicitly include hardware such as a digital signal processor (DSP), and a read-only memory (ROM), a random access memory (RAM), or a non-volatile storage medium for storing software.

In the claims, an element suggested as an element for performing a specific operation may include any arbitrary method of performing the specific operation. Examples of this element may include a combination of circuit elements capable of performing the specific operation, or software having an arbitrary form, e.g., firmware or microcode, which is combined with an appropriate circuit for executing software for performing the specific operation.

In the description of the exemplary embodiments, the expression ‘an exemplary embodiment’ and various modifications of this expression indicate that specific features, structure, and characteristics related to the exemplary embodiment are included in at least one exemplary embodiment. Thus, the expression ‘an exemplary embodiment’ and arbitrary other modifications thereof disclosed in the description of the exemplary embodiments do not always indicate the same exemplary embodiment.

In the description of the exemplary embodiments, the expression ‘at least one of’, for example, ‘at least one of A and B’, is used to inclusively indicate that only the first option (A) is selected, only the second option (B) is selected, or both the first and second operations (A and B) are selected. In addition, the expression ‘at least one of A, B, and C’ is used to inclusively indicate that only the first option (A) is selected, only the second option (B) is selected, only the third option (C) is selected, only the first and second options (A and B) are selected, only the second and third options (B and C) are selected, only the first and third options (A and C) are selected, or all three options (A, B, and C) are selected. When more than three items are listed in relation to this expression, the meaning thereof would be apparent to those of ordinary skill in the art.

Exemplary embodiments have been described above.

While the exemplary embodiments have been particularly shown and described with reference to certain exemplary embodiments thereof, it will be understood by those of ordinary skill in the art that various changes in form and details may be made therein without departing from the spirit and scope of the exemplary embodiments as defined by the appended claims. The exemplary embodiments should be considered in a descriptive sense only and not for purposes of limitation. Therefore, the scope of the exemplary embodiments is defined not by the detailed description of the exemplary embodiments but by the appended claims, and all differences within the scope will be construed as being included in the exemplary embodiments.

1. A method of generating a three-dimensional (3D) image data stream, the method comprising:
encoding a first partial image comprising half of data of a 3D image comprising a first viewpoint image in full resolution and a second viewpoint image in full resolution;
encoding a second partial image comprising a remaining half of the data of the 3D image, the remaining half of the data not being included in the first partial image;
generating streams of the encoded first partial image and the encoded second partial image based on a stream generating method determined from among a first stream generating method that inserts information about the first partial image and information about the second partial image into one stream, and a second stream generating method that inserts the information about the first partial image into a basic layer stream and the information about the second partial image into an enhancement layer stream; and
generating an information stream comprising information indicating the determined stream generating method, information indicating whether image data included in a current stream among the generated streams corresponds to the first partial image or the second partial image, and information indicating whether the image data included in the current stream corresponds to the first viewpoint image or the second viewpoint image.

2. The method of claim 1, wherein the first partial image and the second partial image are respectively provided with half of the data of the 3D image according to one of a side-by-side method, a top-bottom method, a column interleaving method, a row interleaving method, a temporal interleaving method, and a checkerboard interleaving method.

3. The method of claim 1, wherein the first stream generating method distinguishes the information about the first partial image and the information about the second partial image included in the one stream by using a temporal identifier (ID).

4. The method of claim 1, wherein the generating of the information stream comprises inserting the information indicating the determined stream generating method, the information indicating whether the image data included in the current stream corresponds to the first partial image or the second partial image, and the information indicating whether the image data included in the current stream corresponds to the first viewpoint image or the second viewpoint image, into a supplemental enhancement information (SEI) message.

5. The method of claim 1, wherein the information stream comprises, if the current stream is generated based on the first stream generating method, a flag indicating whether to insert the encoded first partial image and the encoded second partial image into different temporal layers that are included in the current stream and distinguished by using a temporal ID, a flag indicating whether data included in the different temporal layers corresponds to the first partial image or the second partial image, and a flag indicating whether the data included in the different temporal layers corresponds to the first viewpoint image or the second viewpoint image.

6. The method of claim 1, wherein the information stream comprises, if the current stream is generated based on the second stream generating method, a flag indicating whether data included in the current stream corresponds to the first partial image or the second partial image, and a flag indicating whether the data included in the current stream corresponds to the first viewpoint image or the second viewpoint image.

7. A method of reproducing a three-dimensional (3D) image data stream, the method comprising:
obtaining a current stream comprising at least one of a first partial image that comprises half of data of a 3D image comprising a first viewpoint image in full resolution and a second viewpoint image in full resolution, and a second partial image that comprises a remaining half of the data of the 3D image, the remaining half of the data not being included in the first partial image;
obtaining an information stream comprising information indicating a stream generating method used to generate the current stream from among a first stream generating method that inserts information about the first partial image and information about the second partial image into one stream, and a second stream generating method that inserts the information about the first partial image into a basic layer stream and the information about the second partial image into an enhancement layer stream, information indicating whether image data included in the current stream corresponds to the first partial image or the second partial image, and information indicating whether the image data included in the current stream corresponds to the first viewpoint image or the second viewpoint image;
obtaining the first partial image and the second partial image from the current stream or from the current stream and another stream obtained separately from the current stream, based on the information indicating the stream generating method, the information indicating whether the image data included in the current stream corresponds to the first partial image or the second partial image, and the information indicating whether the image data included in the current stream corresponds to the first viewpoint image or the second viewpoint image, included in the information stream; and
reproducing the 3D image in full resolution by using the obtained first partial image and the obtained second partial image.

8. The method of claim 7, wherein the first partial image and the second partial image are respectively provided with half of the data of the 3D image according to one of a side-by-side method, a top-bottom method, a column interleaving method, a row interleaving method, a temporal interleaving method, and a checkerboard interleaving method.

9. The method of claim 7, wherein the first stream generating method distinguishes the information about the first partial image and the information about the second partial image included in the one stream by using a temporal identifier (ID).

10. The method of claim 7, wherein the information stream is transmitted through a supplemental enhancement information (SEI) message.

11. The method of claim 7, wherein the information stream comprises, if the current stream is generated based on the first stream generating method, a flag indicating whether to insert the first partial image and the second partial image into different temporal layers that are included in the current stream and distinguished by using a temporal ID, a flag indicating whether data included in the different temporal layers corresponds to the first partial image or the second partial image, and a flag indicating whether the data included in the different temporal layers corresponds to the first viewpoint image or the second viewpoint image.

12. The method of claim 7, wherein the information stream comprises, if the current stream is generated based on the second stream generating method, a flag indicating whether data included in the current stream corresponds to the first partial image or the second partial image, and a flag indicating whether the data included in the current stream corresponds to the first viewpoint image or the second viewpoint image.

13. The method of claim 7, wherein the reproducing comprises:
decoding the first viewpoint image in full resolution and the second viewpoint image in full resolution by using the obtained first partial image and the obtained second partial image; and
reproducing the 3D image in full resolution by using the decoded first viewpoint image and the decoded second viewpoint image in full resolution.

14. An apparatus configured to generate a three-dimensional (3D) image data stream, the apparatus comprising:
a first image encoder configured to encode a first partial image comprising half of data of a 3D image comprising a first viewpoint image in full resolution and a second viewpoint image in full resolution;
a second image encoder configured to encode a second partial image comprising a remaining half of the data of the 3D image, the remaining half of the data not being included in the first partial image;
an image data stream generator configured to generate streams of the encoded first partial image and the encoded second partial image based on a stream generating method determined from among a first stream generating method that inserts information about the first partial image and information about the second partial image into one stream, and a second stream generating method that inserts the information about the first partial image into a basic layer stream and the information about the second partial image into an enhancement layer stream; and
an information stream generator configured to generate an information stream comprising information indicating the determined stream generating method, information indicating whether image data included in a current stream among the generated streams corresponds to the first partial image or the second partial image, and information indicating whether the image data included in the current stream corresponds to the first viewpoint image or the second viewpoint image.

15. An apparatus configured to reproduce a three-dimensional (3D) image data stream, the apparatus comprising:
an image data stream obtainer configured to obtain a current stream comprising at least one of a first partial image that comprises half of data of a 3D image comprising a first viewpoint image in full resolution and a second viewpoint image in full resolution, and a second partial image that comprises a remaining half of the data of the 3D image, the remaining half of the data not being included in the first partial image;
an information stream obtainer configured to obtain an information stream comprising information indicating a stream generating method used to generate the current stream from among a first stream generating method that inserts information about the first partial image and information about the second partial image into one stream, and a second stream generating method that inserts the information about the first partial image into a basic layer stream and the information about the second partial image into an enhancement layer stream, information indicating whether image data included in the current stream corresponds to the first partial image or the second partial image, and information indicating whether the image data included in the current stream corresponds to the first viewpoint image or the second viewpoint image;
an image decoder configured to obtain the first partial image and the second partial image from the current stream or from the current stream and another stream obtained separately from the current stream, based on the information indicating the stream generating method, the information indicating whether the image data included in the current stream corresponds to the first partial image or the second partial image, and the information indicating whether the image data included in the current stream corresponds to the first viewpoint image or the second viewpoint image, included in the obtained information stream, and decode the obtained first partial image and the obtained second partial image; and
a 3D image de-multiplexer configured to generate the 3D image in full resolution by reconstructing the decoded first partial image and the decoded second partial image based on the information indicating the stream generating method, the information indicating whether the image data included in the current stream corresponds to the first partial image or the second partial image, and the information indicating whether the image data included in the current stream corresponds to the first viewpoint image or the second viewpoint image, included in the obtained information stream.
